(19) United States
(12) Patent Application Publication
(10) Pub. No.: US 2025/0232006 A1
(43) Pub. Date: Jul. 17, 2025

(54) AUTOMATED IDENTIFICATION OF SERIAL OR SEQUENTIAL DATA PATTERNS BY MARKER FINGERPRINTING

(71) Applicant: HXMX LLC, Arvada, CO (US)

(72) Inventors: Alan Lindsey, Arvada, CO (US); Aaron Hugen, Parker, CO (US); Connor McLean, Highlands Ranch, CO (US)

(73) Assignee: HXMX LLC, Arvada, CO (US)

(21) Appl. No.: 19/020,939

(22) Filed: Jan. 14, 2025

Related U.S. Application Data
(60) Provisional application No. 63/620,873, filed on Jan. 14, 2024.

(51) Int. Cl. G06F 18/15; G06F 18/2135; G06T 11/20

(52) U.S. Cl. CPC G06F 18/15; G06F 18/2135; G06T 11/206

(57) ABSTRACT

The Marker Fingerprinting system provides a method for identifying and correlating serial or sequential data patterns across diverse domains such as geological, biological, and financial datasets. This innovation transforms single- or multi-attribute data series into feature matrices, generating unique hash tokens—or fingerprints—that encapsulate specific data patterns. Using advanced signal analysis and spectral transformations, it enables efficient processing and pattern recognition within complex datasets. Fingerprints from reference patterns are matched against target datasets, with quantitative confidence metrics derived from weighted algorithms assessing match accuracy. Iterative data conditioning enhances robustness by addressing noise and inconsistencies, ensuring reliability at scale. The invention improves decision-making by delivering rapid and accurate pattern identification with quantified reliability, making it particularly suited for applications like geological top picking, seismic data analysis, and other fields requiring precise data correlation

### CROSS-REFERENCE TO RELATED APPLICATIONS

This application claims the benefit of U.S. Provisional Application 63/620,873 filed Jan. 14, 2024, titled “AUTOMATED IDENTIFICATION OF SERIAL OR SEQUENTIAL DATA PATTERNS BY MARKER FINGERPRINTING,” which is herein incorporated by reference in its entirety.

### BACKGROUND

### Field of the Art

The invention disclosed herein is related to data processing systems, and more particularly, to processing serial or sequential data.

### Discussion of the State of the Art

Well log data is a crucial source of information for characterizing subsurface geology and identifying key geological features, such as formation tops. Accurate and efficient interpretation of well log data is essential for various applications in the oil and gas industry, including reservoir modeling, well correlation, and stratigraphic analysis. However, the process of identifying geological tops from well log data poses several challenges.

Traditionally, top picking has been performed manually by skilled geologists who visually examine one-dimensional (1D) curves of log data and rely on their expertise to correlate tops between wells. While this approach can be effective, it is time-consuming, labor-intensive, and subject to human inconsistencies and errors. The subjective nature of manual interpretation makes it difficult to quantify the confidence in the picked tops, leading to uncertainties in the resulting geological models.

To address the limitations of manual picking, various algorithmic and machine learning techniques have been developed for automated top picking. Basic algorithmic methods typically analyze a single log curve at a time, such as gamma ray or resistivity, to match patterns and identify tops. However, these simplistic approaches often fail to fully utilize the rich multi-dimensional nature of well log data and lack the flexibility to handle the inherent variability in data quality and geological characteristics across different wells and regions. Consequently, these methods may produce suboptimal results, particularly in complex geological settings or when dealing with large datasets.

More advanced solutions employing neural networks and other machine learning algorithms have shown promise in improving the accuracy of top picking. These methods can learn from large volumes of labeled data and capture complex patterns and relationships in the well log data. However, the “black box” nature of these models often limits their interpretability, making it difficult for geologists to understand the reasoning behind the picked tops. The lack of transparency in these models can hinder the trust and adoption of automated top picking solutions in the industry.

Moreover, a common challenge faced by all existing top picking methods is the lack of robust data standardization and conditioning. Well log data frequently suffers from quality issues, such as noise, gaps, and inconsistencies, which can hinder accurate analysis and comparison between wells. Most prior art solutions do not adequately address this problem, leading to suboptimal results and reduced confidence in the picked tops.

Another limitation of existing methods is the inability to effectively quantify and communicate the uncertainty associated with the picked tops. Geologists often rely on their experience and judgment to assess the reliability of the picks, but this subjective approach can lead to inconsistencies and difficulties in decision-making. The lack of quantitative confidence measures in existing solutions makes it challenging to integrate top picking results into downstream workflows and risk assessment processes.

Furthermore, the increasing volume and complexity of well log data in modern exploration and production activities require more efficient and scalable solutions for top picking. Manual interpretation becomes impractical when dealing with hundreds or thousands of wells, while simplistic algorithmic approaches may not capture the full range of geological variability. The ability to process large datasets in a timely and consistent manner is crucial for making informed decisions and optimizing operations in the oil and gas industry.

The geological domain also faces challenges with existing automated approaches to tops picking. Current systems suffer from a high incidence of false positives, where the automated pick does not align with a geologist's assessment. This issue necessitates extensive manual review and correction, thereby negating the time-saving potential of automation. Moreover, the use of neural networks, a prevalent method in automated tops picking, is hampered by the need for substantial training on large datasets and significant computing resources. These networks often rely on manual picks for training, but these manual picks are themselves prone to errors, thus perpetuating inaccuracies in the system.

Dynamic warping, another technique employed for tops picking, faces its own set of challenges. While it can produce dense and seemingly accurate picks, it can correlate any two curves regardless of their actual relationship. This indiscriminate correlation can lead to misleading results. Similarly, simultaneous correlation, which attempts to address this issue, involves solving large simultaneous equations, making it a costly and complex process. Furthermore, it often results in an overwhelming number of picks, adding to the difficulty in validation and interpretation by users.

These issues are not confined to the geological field alone. Similar challenges are encountered in various domains dealing with multi-attribute serial datasets, such as 3D seismic data interpretation, biological data analysis, financial data processing, signal processing, and more. In each of these fields, there is a need for efficient, accurate, and reliable methods to interpret and analyze complex datasets with multiple attributes, whether these datasets are in the form of time, depth, distance, or other indices like molecular location on a DNA chain.

In summary, the identification of geological tops from well log data remains a significant challenge due to the limitations of manual interpretation, the suboptimal performance of simplistic algorithmic approaches, the lack of interpretability in advanced machine learning models, and the inadequate handling of data quality issues. There is a clear need for an innovative solution that can address these limitations and provide accurate, efficient, and interpretable top picking results with quantified confidence measures to support geological interpretation and decision-making in the oil and gas industry.

### SUMMARY

The present invention relates to a method and system for identifying geological tops from well log data using audio-like data conversion and analysis techniques. The invention addresses the limitations of manual interpretation, simplistic algorithmic approaches, and opaque machine learning models by introducing a novel workflow that combines matrix conversion techniques, data signature generation, confidence metric calculation, and iterative data conditioning.

The invention converts well log data into an audio-like format using matrix conversion techniques, enabling the application of sophisticated signal processing and analysis algorithms commonly used in audio and speech recognition. By transforming the well log data into a domain that is amenable to advanced signal processing techniques, the invention unlocks new possibilities for extracting meaningful features and patterns from the data.

The method generates unique data signatures from the converted data by identifying key features, transforming them into vectors, and applying hashing techniques. These signatures serve as fingerprints for efficient matching and comparison between wells, allowing for rapid and accurate identification of geological tops across large datasets. The data signature generation process captures the essential characteristics of the well log data while reducing the dimensionality and complexity of the problem.

A key aspect of the invention is its ability to calculate and combine confidence metrics from multiple matching techniques using a weighted averaging approach. This provides geologists with quantitative and interpretable information about the reliability of the picked tops, facilitating better-informed decision-making. The confidence metrics are derived from the analysis of the data signatures and take into account various factors such as the similarity between signatures, the consistency of the picks across multiple wells, and the quality of the input data. By integrating confidence measures into the top picking workflow, the invention enables geologists to assess the uncertainty associated with the results and make more robust interpretations.

Furthermore, the invention incorporates iterative data conditioning and standardization, using insights from initial matching results to progressively improve data quality and refine the top picking accuracy. The method identifies and corrects for common data quality issues, such as noise, gaps, and inconsistencies, by leveraging the information gained from the matching process. This iterative approach ensures that the top picking results are based on the best possible representation of the well log data, enhancing the reliability and consistency of the output.

The invention offers several advantages over prior art solutions. By leveraging audio-like data conversion and advanced signal processing techniques, the method can efficiently handle large volumes of multi-dimensional well log data and capture complex patterns and relationships that may be missed by simplistic algorithmic approaches. The generation of unique data signatures enables fast and accurate matching between wells, reducing the time and effort required for top picking compared to manual interpretation.

Moreover, the calculation and combination of confidence metrics provide a quantitative basis for assessing the reliability of the picked tops, addressing the limitations of subjective manual interpretation and the lack of interpretability in advanced machine learning models. The iterative data conditioning and standardization process ensures that the top picking results are robust to data quality issues, improving the overall accuracy and consistency of the output.

In summary, the present invention provides a novel and improved method for identifying geological tops from well log data by combining audio-like data conversion, data signature generation, confidence metric calculation, and iterative data conditioning. The invention overcomes the limitations of existing approaches and delivers accurate, efficient, and interpretable top picking results with quantified confidence measures, enabling better geological interpretation and decision-making in the oil and gas industry.

The present invention provides a novel and non-obvious method for identifying geological tops that goes beyond simply automating existing manual processes. While a geologist may visually inspect individual well logs to identify tops, the claimed invention employs a fundamentally different approach by first converting the well log data into an audio-compatible format using a unique flattening and upsampling process. This allows the data to be analyzed in the frequency domain using fast Fourier transforms, a technique not practically employable by a human. The resulting spectrogram data is then converted into distinct fingerprints, which are stored and used to search for matching patterns across multiple wells. This fingerprinting and matching process enables rapid identification of geological tops in a target well based on similarities to reference wells, a process that would be prohibitively time-consuming for a human to replicate.

Furthermore, the claimed invention generates quantitative confidence metrics for each identified top using multiple weighted similarity algorithms. These confidence metrics provide an objective measure of the reliability of each top pick, a feature not available in traditional manual picking workflows. The confidence metrics can also be used to identify areas of uncertainty requiring further investigation, allowing geologists to focus their efforts on the most challenging or ambiguous sections. By automatically calculating and displaying these confidence metrics, the invention provides geologists with a powerful tool for evaluating the quality of picked tops and understanding the relationships between different wells. This level of quantitative analysis and interpretation goes beyond what is possible with manual top picking alone. The combination of the objective measures of confidence with the identification of geological tops produces not only an objective measure of confidence but an objective fingerprint (or data signature) of each top. This objective definition provides the possibility for a new standard for geological tops for geologists to use in their work that they would not be able to identify via manual identification

In summary, the claimed invention represents a significant advancement over existing manual and automated top picking methods by employing a novel data processing pipeline, fingerprint matching across wells, and quantitative confidence metrics. These features enable more efficient, accurate, and insightful identification of geological tops compared to traditional approaches.

The present invention integrates the abstract idea into a practical application by providing specific improvements to existing computer technology in the field of geological top picking. The current manual and automated methods for identifying geological tops suffer from limitations such as being time-consuming, subjective, and lacking quantitative measures of confidence. The claimed invention addresses these problems by providing a novel top picking method that is more efficient, objective, and insightful compared to traditional approaches.

The steps of converting the well log data into an audio-compatible format using flattening and upsampling, generating fingerprints from the spectrogram data, and using the fingerprints to identify tops across multiple wells enable the rapid and accurate identification of geological tops in a manner that would be impractical for a human to replicate. Furthermore, the steps of calculating confidence metrics using multiple weighted similarity algorithms and storing/displaying the tops with their associated confidence metrics provide geologists with a powerful tool for evaluating the quality of the picked tops and understanding the relationships between wells. These quantitative measures of confidence are not available in traditional manual picking workflows.

The invention described herein, known as the Marker Fingerprinting approach, is a pattern recognition process for serial and sequential data, which can be applied to, but is not limited to the geological domain. This novel method transforms multi-attribute or single-attribute data series into a feature matrix, which is then converted into a set of searchable hash tokens or fingerprints. These fingerprints represent specific patterns within the data, enabling efficient and accurate identification and correlation of geological features such as well logs.

The innovation addresses the shortcomings of traditional and automated tops picking methods in geology. By creating a database of fingerprints for each well, the Marker Fingerprinting approach enables rapid and precise comparison with other wells in the area. This method is significantly less computationally intensive than existing approaches, as it involves database searches for hash tokens instead of real-time analysis of extensive curve data. The batch processing of curve data into fingerprints further enhances efficiency, preparing the system for real-time analysis without the need for extensive computing resources.

One of the advantages of this approach is the reduction of false positives, achieved through multiple confidence metrics that necessitate a greater number of parameters for confirming a true geological feature match. The ability to simultaneously utilize multiple log curves increases the distinctiveness of tops, further reducing the likelihood of incorrect correlations. Additionally, the system can identify missing sections in the reference or target wells, aiding in the detection of geological features like faults or unconformities.

Marker Fingerprinting also extends beyond the geological domain, capable of handling both time-based and non-time-related serial data and analyzing multiple attributes simultaneously. This flexibility allows the technique to adapt to various applications, including 3D seismic interpretation, where it condenses large datasets into a searchable database for rapid pattern recognition.

The probabilistic nature of this approach means it does not require massive datasets for system training. With its original statistical matching technique, only a few reference wells or reference entities are necessary to tune the system for broader applications. This aspect is particularly advantageous in regions where datasets may be limited.

Furthermore, the Marker Fingerprinting technique is adaptable to the specific requirements of geological analysis. The system can also stretch and squeeze the reference window or use specialized hashing techniques with or without filtering to match targets that have undergone significant geological transformations. This adaptability is helpful in accurately identifying and correlating geological markers across different wells and datasets.

In summary, the Marker Fingerprinting approach offers a solution to the challenges of manual and automated tops picking in geology. Its efficient, accurate, and less resource-intensive methodology provides a robust tool for geological interpretations, making it an invaluable asset in the exploration, development, and modeling of geological reservoirs. Moreover, its adaptability and probabilistic nature extend its utility beyond geology, as discussed herein and as would be apparent to a person of ordinary skill in the art.

### BRIEF DESCRIPTION OF THE DRAWINGS

The accompanying drawings illustrate several embodiments and, together with the description, serve to explain the principles of the invention according to the embodiments. It will be appreciated by one skilled in the art that the particular arrangements illustrated in the drawings are merely exemplary and are not to be considered as limiting of the scope of the invention or the claims herein in any way:

FIG. 1 illustrates a high-level conceptual architecture for a system for automated identification of serial data patterns by marker fingerprinting in accordance with an exemplary embodiment of the invention;

FIG. 2 illustrates a Pattern Identification Engine for a system for automated identification of similar serial data patterns by marker fingerprinting in accordance with an exemplary embodiment of the present invention;

FIG. 3 illustrates an exemplary process for automated identification of serial data patterns by marker fingerprinting according to one embodiment of the invention;

FIG. 4 illustrates one embodiment of the computing architecture that supports an embodiment of the inventive disclosure;

FIG. 5 illustrates components of a system architecture that supports an embodiment of the inventive disclosure;

FIG. 6 illustrates components of a computing device that supports an embodiment of the inventive disclosure;

FIG. 7 illustrates components of a computing device that supports an embodiment of the inventive disclosure;

FIG. 8 includes three sample curves (e.g., well log category values arranged according to the depth at which they are observed) in a tabular format;

FIG. 9 illustrates an audio waveform from a Denver-Julesburg (DJ) well above the resulting spectrogram, which can be used for hash matching;

FIG. 10 illustrates a search for a geological feature match, in accordance with some implementations;

FIG. 11 illustrates a process of searching for a geological feature match (e.g., marker), in accordance with some implementations;

FIG. 12 illustrates a matching process using well logs containing measurements from three categories; and

FIG. 13 illustrates a process for performing well matching, in accordance with some implementations.

FIG. 14 illustrates a process for performing well matching, in accordance with some implementations.

### DETAILED DESCRIPTION

One or more different embodiments may be described in the present application. Further, for one or more of the embodiments described herein, numerous alternative arrangements may be described; it should be appreciated that these are presented for illustrative purposes only and are not limiting of the embodiments contained herein or the claims presented herein in any way. One or more of the arrangements may be widely applicable to numerous embodiments, as may be readily apparent from the disclosure. In general, arrangements are described in sufficient detail to enable those skilled in the art to practice one or more of the embodiments, and it should be appreciated that other arrangements may be utilized and that structural, logical, software, electrical and other changes may be made without departing from the scope of the embodiments. Particular features of one or more of the embodiments described herein may be described with reference to one or more particular embodiments or figures that form a part of the present disclosure, and in which are shown, by way of illustration, specific arrangements of one or more of the aspects. It should be appreciated, however, that such features are not limited to usage in the one or more particular embodiments or figures with reference to which they are described. The present disclosure is neither a literal description of all arrangements of one or more of the embodiments nor a listing of features of one or more of the embodiments that must be present in all arrangements.

Headings of sections provided in this patent application and the title of this patent application are for convenience only and are not to be taken as limiting the disclosure in any way.

Devices that are in communication with each other need not be in continuous communication with each other, unless expressly specified otherwise. In addition, devices that are in communication with each other may communicate directly or indirectly through one or more communication means or intermediaries, logical or physical.

A description of an aspect with several components in communication with each other does not imply that all such components are required. To the contrary, a variety of optional components may be described to illustrate a wide variety of possible embodiments and in order to more fully illustrate one or more embodiments. Similarly, although process steps, method steps, algorithms or the like may be described in a sequential order, such processes, methods and algorithms may generally be configured to work in alternate orders, unless specifically stated to the contrary. In other words, any sequence or order of steps that may be described in this patent application does not, in and of itself, indicate a requirement that the steps be performed in that order. The steps of described processes may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to one or more of the embodiments, and does not imply that the illustrated process is preferred. Also, steps are generally described once per aspect, but this does not mean they must occur once, or that they may only occur once each time a process, method, or algorithm is carried out or executed. Some steps may be omitted in some embodiments or some occurrences, or some steps may be executed more than once in a given aspect or occurrence.

When a single device or article is described herein, it will be readily apparent that more than one device or article may be used in place of a single device or article. Similarly, where more than one device or article is described herein, it will be readily apparent that a single device or article may be used in place of the more than one device or article.

The functionality or the features of a device may be alternatively embodied by one or more other devices that are not explicitly described as having such functionality or features. Thus, other embodiments need not include the device itself.

Techniques and mechanisms described or referenced herein will sometimes be described in singular form for clarity. However, it should be appreciated that particular embodiments may include multiple iterations of a technique or multiple instantiations of a mechanism unless noted otherwise. Process descriptions or blocks in figures should be understood as representing modules, segments, or portions of code which include one or more executable instructions for implementing specific logical functions or steps in the process. Alternate implementations are included within the scope of various embodiments in which, for example, functions may be executed out of order from that shown or discussed, including substantially concurrently or in reverse order, depending on the functionality involved, as would be understood by those having ordinary skill in the art.

The detailed description set forth herein in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

### Conceptual Architecture

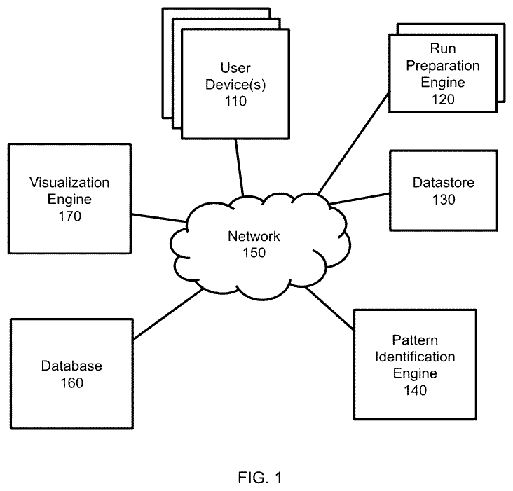

FIG. 1 illustrates an exemplary embodiment of the invention at a high-level. In one embodiment, the system is comprised of User Device(s) 110, Data Preparation Engine 120, Datastore 130, Pattern Identification Engine 140, Network 150, Database 160, and Visualization Engine 170. These systems seamlessly communicate and interact over the Network 150, facilitating the flexible utilization of the invention across diverse technological environments. Additionally, each of these systems can be used in isolation. This allows the components to be segmented and used in various applications. This also makes the product adaptable to various usages across different domains, user device(s) 110, and a network 150 over which the various systems communicate and interact. The various components described herein are exemplary and for illustration purposes only and any combination or subcombination of the various components may be used as would be apparent to one of ordinary skill in the art. The system may be reorganized or consolidated, as understood by a person of ordinary skill in the art, to perform the same tasks on one or more other servers or computing devices without departing from the scope of the invention.

The Run Preparation Engine 120 may be a software component designed to process and prepare data for subsequent analysis. The engine may retrieve parameters and data locations from a User Device 110. The data received from User Device 110 may be in various formats and may require certain preprocessing steps to be suitable for the subsequent analysis. The Run Preparation Engine (120) retrieves parameters and data locations from the User Device (110) and prepares this data for in-depth analysis. This engine may be tasked with a series of steps to ensure that the data is in an optimal state for subsequent processing.

The process begins with mnemonic standardization, a step where the naming conventions and labels of data attributes are standardized. This is helpful for ensuring that the data from various sources is consistent and can be integrated seamlessly. Following this, data normalization is carried out, when needed, to adjust the range of data values to a uniform scale, facilitating comparative analysis and maintaining consistency across different datasets.

Another task performed by the Run Preparation Engine (120) may be data series synchronization. In cases like well logs, this involves depth correction and aligning all data series to be on the same depth with each other, which is vital for the accuracy of the analysis. The engine also selects relevant subsets of data, focusing on the most pertinent information for the analysis at hand.

The run preparation engine 120 may perform Data reformatting, where the engine adjusts data into formats compatible with the analysis tools. This ensures that the data can be correctly interpreted and processed by subsequent systems. Additionally, when needed the engine performs deviation corrections, particularly to True Vertical Depth (TVD) or True Stratigraphic Thickness (TST) in geological data like well logs, along with associated resampling to a standard sampling interval. These corrections ensure that the data accurately reflects the geological structures and measurements. In cases where oil and gas wells exhibit high deviation, necessitating the segmentation of the well into multiple overlapping sections, each segment can be individually corrected to True Vertical Depth (TVD) or True Stratigraphic Thickness (TST) for the purpose of well log correlation. Run Preparation Engine 120 manages that process and determination of center locations for each segment.

In alternative embodiments, the Run Preparation Engine 120 may perform additional tasks or different tasks depending on the specific requirements of the subsequent analysis. These tasks may include, but are not limited to, data cleaning, outlier detection, and data transformation. Other alternatives that could enhance the functionality of the Run Preparation Engine 120 include automated systems for enhancing data quality, like AI-driven data cleansing and correction algorithms, which could streamline the preparation process. Real-time data processing capabilities might be beneficial for applications requiring immediate insights. Sophisticated noise reduction algorithms could be helpful for datasets with complex or subtle noise patterns, and machine learning algorithms could automate and optimize various data preparation tasks.

In the architecture of the invention, Datastore 130 may be designed as a multifaceted storage repository, managing and storing a broad range of data essential for analysis. Its primary function is to handle large, serial, or sequential datasets, along with storing reference marker information and various parameters critical to the analysis process.

Datastore 130 may be adept at dealing with diverse data types, especially large datasets that are serial or sequential, which are frequently encountered in complex analytical tasks. The capability to store reference marker information is particularly valuable in fields like geology, where such markers are helpful for identifying and analyzing different strata. Additionally, the storage of various parameters used throughout the analysis ensures that these critical settings are accessible when needed, streamlining the process.

The adaptability of Datastore (130) extends to its compatibility with multiple storage formats and systems. It can efficiently handle simple flat file formats, which are beneficial for less complex data structures or when ease of access is a priority. For unstructured or semi-structured data, Datastore (130) supports NoSQL databases, offering flexibility and scalability in data modeling. The system is also compatible with relational databases (RDBMS), which are suited for structured storage and complex querying capabilities. Furthermore, Datastore (130) can integrate with various other storage systems, catering to specific storage needs or preferences.

Incorporating cloud-based storage solutions into Datastore (130) may offer enhanced scalability, flexibility, and the convenience of remote access, making data management more efficient. For extremely large datasets, distributed storage systems like Hadoop or distributed databases could be utilized to improve performance and storage capacity. Additionally, integrating blockchain technology could be considered for applications where data integrity and security are paramount.

The Pattern Identification Engine (140) may process reference and/or target datasets for pattern analysis. This engine handles the data through a series of steps, starting from creating feature matrices to producing outputs for visualization.

The Pattern Identification Engine (140) may start by generating feature matrices from the datasets, where it extracts essential features that indicate specific patterns or markers in the data. The next step involves creating fingerprints from these features. These fingerprints, which are unique representations of the data's characteristics, are then stored for later stages of pattern matching.

Using constraints calculated by the Run Preparation Engine (120), along with confidence metrics, the Pattern Identification Engine (140) proceeds to identify corresponding fingerprints in the target data. This step involves matching the fingerprints corresponding to geological features from the reference dataset with those in the target dataset, using the constraints to guide the search.

After identifying the patterns, the engine produces outputs that include the markers found, along with confidence and tuning metrics. These outputs are prepared for visualization, enabling users to understand and analyze the patterns detected in the data.

The Pattern Identification Engine (140) may include using machine learning techniques for more sophisticated feature extraction and pattern identification. Dynamic constraint adjustment, where constraints are modified based on feedback from ongoing analyses, could also be implemented for more responsive pattern identification. Additionally, automated tuning mechanisms, such as, but not limited to grid search, that adjust parameters based on past analysis feedback could help in optimizing the engine's performance.

In one embodiment, Database 160 may be a storage and retrieval system, with a focus on managing hashes integral to marker fingerprinting processes. This database helps organize and handle hash data and plays a part in efficiently identifying and matching marker signatures within extensive datasets. Tailored specifically for the unique demands of marker fingerprinting, Database 160 may be designed to provide a solution that is both reliable and scalable, ensuring the storage and quick retrieval of hash-based serial and sequential data representations.

Database 160 may enable organization and management of hash data. This includes optimizing the storage structure to support rapid searches and retrievals, essential for the fast-paced and accuracy-driven requirements of marker fingerprinting. The database's design takes into account the need to handle large volumes of data, along with the specific types of queries that are common in fingerprinting processes.

In one embodiment, Database 160 supports several database options, including but not limited to Relational Databases (RDBMS) that are well-suited for structured data and offer robust query capabilities; NoSQL Databases, which are flexible and scalable, making them ideal for unstructured or semi-structured data; Graph Databases, efficient for storing and querying data with complex relationships; Columnar Databases, optimized for large volume data reading and writing; Distributed File Systems for handling large datasets across multiple servers; In-Memory Databases for fast data retrieval by storing data in RAM, suitable for real-time processing; and Object Storage, which is effective for storing large amounts of unstructured data.

Additionally, Database 160 may be capable of accommodating extra data alongside the hashes, provided that the inclusion of this additional data does not impede the performance of hash retrieval. This feature allows the database to store supplementary information that might be useful in the marker fingerprinting process or for related analytical tasks. The system design may be able to handle these various data types and create hashes based on the contents stored in the database. In one embodiment, it is pointed to the data column in the database, which allows it to remain flexible. In some applications it may be appropriate to combine Database 160 and Datastore 130 into a single system.

The Visualization Engine (170) may transform the outputs from the Pattern Identification Engine (140) into visual representations. The Visualization Engine (170) may create visualizations that cater to the needs of various users, including analysts and data scientists, each with distinct roles and requirements.

A function of the Visualization Engine (170) may be to process pattern identification outputs, which encompass identified patterns, confidence metrics, and other relevant data. It then converts this information into visual formats that are easy to interpret and actionable. This conversion allows users to understand and analyze the results of the pattern identification process effectively.

The Visualization Engine (170) may focus on visuals that emphasize confidence metrics and the accuracy of marker placements. This is particularly important in fields like geology, where accurate interpretation of data is helpful. For data scientists, the visualizations are more oriented towards highlighting system performance metrics and identifying areas for potential optimization.

The Visualization Engine (170) may produce a range of visual representations, including log displays for individual wells, cross-sections, and maps. In one embodiment, these visualizations may help audit the results of the hashing and matching algorithms. Additionally, the Visualization Engine (170) may offer customization options for the visualizations to align with the specific requirements of different industries. This customization includes adjusting the types of visuals, the data they present, and their presentation style.

Alternatives to enhance the Visualization Engine (170) could include interactive visualization tools, allowing users to engage more directly with the data, like manipulating parameters or exploring different data layers. Augmented Reality (AR) and Virtual Reality (VR) technologies could also be integrated for a more immersive experience, especially useful in geological applications for creating 3D visualizations of subsurface structures. Machine learning-enhanced visualizations could provide predictive insights or highlight key areas of interest, and customizable dashboard solutions could allow users to tailor the visualizations to their specific needs.

User device(s) 110 include, generally, a computer or computing device including functionality for communicating (e.g., remotely) over a network 150. In one embodiment, User Device 110 serves as an interface enabling users to input comprehensive parameters for system control. These parameters encompass, but are not limited to, specifying data locations, identifying relevant data segments, defining data cleansing procedures, and configuring search criteria. User Device 110 may be versatile, capable of managing both batch processing and/or interacting with a graphical user interface seamlessly integrated into an extensive data analysis and interpretation framework. In some embodiments User Device 110 can encompass all operations.

Broadly, data may be collected from user devices 110, and data requests may be initiated from each user device 110. User device(s) 110 may be a server, a desktop computer, a laptop computer, personal digital assistant (PDA), an in- or out-of-car navigation system, a smart phone or other cellular or mobile phone, or mobile gaming device, among other suitable computing devices. User devices 110 may execute one or more applications, such as a web browser (e.g., Microsoft Windows Internet Explorer, Mozilla Firefox, Apple Safari, Google Chrome, and Opera, etc.), or a dedicated application to submit user data, or to make prediction queries over a network 150.

In particular embodiments, each user device 110 may be an electronic device including hardware, software, or embedded logic components or a combination of two or more such components and capable of carrying out the appropriate functions implemented or supported by the user device 110. For example, and without limitation, a user device 110 may be a desktop computer system, a notebook computer system, a netbook computer system, a handheld electronic device, or a mobile telephone. The present disclosure contemplates any user device 110. A user device 110 may enable a network user at the user device 110 to access network 150. A user device 110 may enable its user to communicate with other users at other user devices 110.

A user device 110 may have a web browser, such as MICROSOFT INTERNET EXPLORER, GOOGLE CHROME or MOZILLA FIREFOX, and may have one or more add-ons, plug-ins, or other extensions, such as TOOLBAR or YAHOO TOOLBAR. A user device 110 may enable a user to enter a Uniform Resource Locator (URL) or other address directing the web browser to a server, and the web browser may generate a Hyper Text Transfer Protocol (HTTP) request and communicate the HTTP request to server. The server may accept the HTTP request and communicate to the user device 110 one or more Hyper Text Markup Language (HTML) files responsive to the HTTP request. The user device 110 may render a web page based on the HTML files from server for presentation to the user. The present disclosure contemplates any suitable web page files. As an example, and not by way of limitation, web pages may render from HTML files, Extensible Hyper Text Markup Language (XHTML) files, or Extensible Markup Language (XML) files, according to particular needs. Such pages may also execute scripts such as, for example and without limitation, those written in JAVASCRIPT, JAVA, MICROSOFT SILVERLIGHT, combinations of markup language and scripts such as AJAX (Asynchronous JAVASCRIPT and XML), and the like. Herein, reference to a web page encompasses one or more corresponding web page files (which a browser may use to render the web page) and vice versa, where appropriate.

The user device 110 may also include an application that is loaded onto the user device 110. The application obtains data from the network 150 and displays it to the user within the application interface.

Exemplary user devices are illustrated in some of the subsequent figures provided herein. This disclosure contemplates any suitable number of user devices, including computing systems taking any suitable physical form. As example and not by way of limitation, computing systems may be an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, or a combination of two or more of these. Where appropriate, the computing system may include one or more computer systems; be unitary or distributed; span multiple locations; span multiple machines; or reside in a cloud, which may include one or more cloud components in one or more networks. Where appropriate, one or more computing systems may perform without substantial spatial or temporal limitation one or more steps of one or more methods described or illustrated herein. As an example, and not by way of limitation, one or more computing systems may perform in real time or in batch mode one or more steps of one or more methods described or illustrated herein. One or more computing system may perform at different times or at different locations one or more steps of one or more methods described or illustrated herein, where appropriate.

Network cloud 150 generally represents a network or collection of networks (such as the Internet or a corporate intranet, or a combination of both) over which the various components illustrated in FIG. 1 (including other components that may be necessary to execute the system described herein, as would be readily understood to a person of ordinary skill in the art). In particular embodiments, network 150 is an intranet, an extranet, a virtual private network (VPN), a local area network (LAN), a wireless LAN (WLAN), a wide area network (WAN), a metropolitan area network (MAN), a portion of the Internet, or another network 150 or a combination of two or more such networks 150. One or more links connect the systems and databases described herein to the network 150. In particular embodiments, one or more links each includes one or more wired, wireless, or optical links. In particular embodiments, one or more links each includes an intranet, an extranet, a VPN, a LAN, a WLAN, a WAN, a MAN, a portion of the Internet, or another link or a combination of two or more such links. The present disclosure contemplates any suitable network 150, and any suitable link for connecting the various systems and databases described herein.

The network 150 connects the various systems and computing devices described or referenced herein. In particular embodiments, network 150 is an intranet, an extranet, a virtual private network (VPN), a local area network (LAN), a wireless LAN (WLAN), a wide area network (WAN), a metropolitan area network (MAN), a portion of the Internet, or another network 421 or a combination of two or more such networks 150. The present disclosure contemplates any suitable network 150.

One or more links couple one or more systems, engines or devices to the network 150. In particular embodiments, one or more links each includes one or more wired, wireless, or optical links. In particular embodiments, one or more links each includes an intranet, an extranet, a VPN, a LAN, a WLAN, a WAN, a MAN, a portion of the Internet, or another link or a combination of two or more such links. The present disclosure contemplates any suitable links coupling one or more systems, engines or devices to the network 150.

In particular embodiments, each system or engine may be a unitary server or may be a distributed server spanning multiple computers or multiple datacenters. Systems, engines, or modules may be of various types, such as, for example and without limitation, web server, news server, mail server, message server, advertising server, file server, application server, exchange server, database server, or proxy server. In particular embodiments, each system, engine or module may include hardware, software, or embedded logic components or a combination of two or more such components for carrying out the appropriate functionalities implemented or supported by their respective servers. For example, a web server is generally capable of hosting websites containing web pages or particular elements of web pages. More specifically, a web server may host HTML files or other file types or may dynamically create or constitute files upon a request, and communicate them to client/user devices or other devices in response to HTTP or other requests from client devices or other devices. A mail server is generally capable of providing electronic mail services to various client devices or other devices. A database server is generally capable of providing an interface for managing data stored in one or more data stores.

In particular embodiments, one or more data storages may be communicatively linked to one or more servers via one or more links. In particular embodiments, data storages may be used to store various types of information. In particular embodiments, the information stored in data storages may be organized according to specific data structures. In particular embodiments, each data storage may be a relational database. Particular embodiments may provide interfaces that enable servers or clients to manage, e.g., retrieve, modify, add, or delete, the information stored in data storage.

The system may also contain other subsystems and databases, which are not illustrated in FIG. 1, but would be readily apparent to a person of ordinary skill in the art. For example, the system may include databases for storing data, storing features, storing outcomes (training sets), and storing models. Other databases and systems may be added or subtracted, as would be readily understood by a person of ordinary skill in the art, without departing from the scope of the invention.

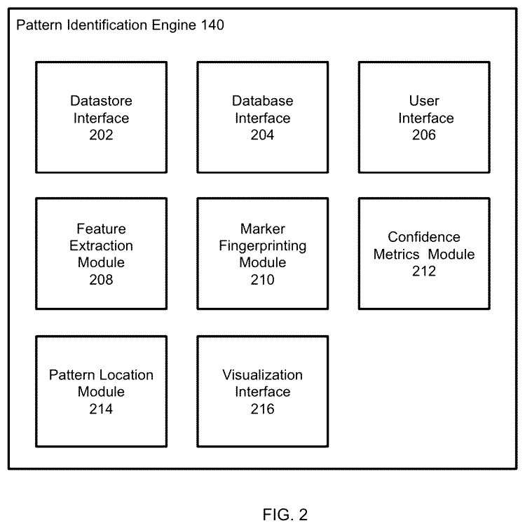

FIG. 2 illustrates a detailed view of the Pattern Identification Engine 140 in accordance with an exemplary embodiment. In one embodiment, the subsystems comprise a Datastore Interface 202, a Database Interface 204, a User Interface 206, Feature Extraction Module 208, Marker Fingerprinting Module 210, Confidence Metrics Module 212, Pattern Identification Module 214, and Visualization Interface 216. The various components described herein are exemplary and for illustration purposes only and any combination or subcombination of the various components may be used as would be apparent to one of ordinary skill in the art. Other systems, interfaces, modules, engines, databases, and the like, may be used, as would be readily understood by a person of ordinary skill in the art, without departing from the scope of the invention. Any system, interface, module, engine, database, and the like may be divided into a plurality of such elements for achieving the same function without departing from the scope of the invention. Any system, interface, module, engine, database, and the like may be combined or consolidated into fewer of such elements for achieving the same function without departing from the scope of the invention. All functions of the components discussed herein may be initiated manually or may be automatically initiated when the criteria necessary to trigger action have been met.

Datastore Interface 202 may be a software and/or hardware subsystem that facilitates information exchange between various modules and Datastore 130. Datastore Interface 202 may enable communication between these components, ensuring that data can be efficiently and effectively transferred and accessed as needed. The Datastore Interface 202 operates by employing various protocols suitable for interactions between datastores and application modules. These protocols govern how data is sent and received, ensuring that the communication is conducted in a manner that is understood by both the sending and receiving components. This may comprise protocols for data formatting, transmission, error checking, and other aspects of data communication. The communication facilitated by the Datastore Interface 202 may involve a wide range of data types, depending on the specific requirements of the modules and the Datastore 130. This may include data related to user inputs, system outputs, internal system states, or any other data that needs to be exchanged between the components. In alternative embodiments, the Datastore Interface 202 could employ different protocols, support different data types, or facilitate communication between different components. The specific design and operation of the interface could be adapted to suit the specific requirements of the system, the data, and the communication processes. For example, the interface could be designed to support additional protocols, to handle different data formats, or to facilitate communication with additional or different modules or datastores. The Database Interface 204 may be a software and/or hardware subsystem that facilitates information exchange among different modules and Database 160.

The Database Interface 204 may operate by using any protocol suitable for interactions between databases and application modules. These protocols govern how data is sent and received, ensuring that the communication is conducted in a manner that is comprehensible by both the sending and receiving components. This may comprise protocols for data formatting, transmission, error checking, and other aspects of data communication. The communication facilitated by the Database Interface 204 may involve a wide range of data types, depending on the specific requirements of the modules and the Database 160. This may comprisedata related to user inputs, system outputs, internal system states, or any other data that needs to be exchanged between the components. In alternative embodiments, the Database Interface 204 could employ different protocols, support different data types, or facilitate communication between different components. The specific design and operation of the interface could be adapted to suit the specific requirements of the system, the data, and the communication processes. For example, the interface could be designed to support additional protocols, to handle different data formats, or to facilitate communication with additional or different modules or databases.

The User Interface 206 may be a software and/or hardware subsystem that acts as a central hub for efficient communication between the system components and User Device(s) 110. This interface may be specifically designed to optimize user interaction, offering an intuitive platform that ensures efficient data exchange and system responsiveness.

The User Interface 206 supports both batch and real-time scenarios. In batch scenarios, the interface allows users to queue up multiple commands or inputs for processing at a later time. In real-time scenarios, the interface allows users to interact with the system and receive immediate feedback or responses. This flexibility in handling different interaction scenarios enhances the usability and versatility of the system. Through User Interface 206, users can interact with and control different aspects of the system. This includes managing inputs, controlling outputs, adjusting system settings, and accessing various system features and functionalities. This centralized hub simplifies the user's interaction with the system, providing a single point of access for all system-related tasks and activities. The User Interface 206 may be visually presented on User Device(s) 110. This visual presentation may be designed to be user-friendly, with an intuitive layout, clear labels, and straightforward controls. The design of the interface enhances accessibility and engagement, making it easy for users to understand and interact with the system. In alternative embodiments, the User Interface 206 could be designed differently or offer different features or functionalities. For example, the interface could be designed to support different types of user devices, to accommodate different user preferences or needs, or to provide additional or different controls or features. The specific design and functionality of the interface could be adapted to suit the specific requirements of the system and the users.

The Feature Extraction Module (208) transforms multi-attribute and/or single-attribute data from various reference or target entities into a unified M×N matrix format. This transformation process generates a feature matrix, which forms a basis for the hash-token representation in the Marker Fingerprinting Module (210).

The operation of the Feature Extraction Module (208) may be guided by inputs and parameters derived from the Run Preparation Engine (120), ensuring that the data is appropriately pre-processed and ready for feature extraction. The module employs three primary methods to achieve its objective: Flattening, Music Conversion, and Direct Matrix Generation. These methods can be applied either individually or in combination, depending on the nature of the data and the specific requirements of the analysis.

The Flattening Method simplifies complex multi-attribute data sets by converting them into a single-dimensional, flat structure, making the data more manageable and suitable for further processing.

The Music Conversion Method transforms data into a format akin to musical notes or audio signals. This approach is especially beneficial for data sets where such transformation can enhance the visibility of key patterns and features inherent in the data.

The Direct Matrix Generation Method generates a feature matrix directly from the data, a straightforward approach that can be particularly effective for certain types of data.

Upon completion of the feature extraction process, the resulting matrices are directed to either the Datastore (130), Database (160), or directly to the Marker Fingerprinting Module (210). This direction is determined based on the optimization criteria of the system and the specific requirements of the task at hand. Alongside these matrices, the module also provides time-depth information and metadata, which are essential for contextualizing the matrices and ensuring accurate interpretation in subsequent processes.

Alternative approaches to feature extraction in this system could include the deployment of more advanced or specialized algorithms or statistical techniques to additional features that then can be used by ML algorithms. Additionally, for more complex data sets, a hybrid approach combining different feature extraction methods could be employed. For applications that require immediate processing, the module could be adapted for real-time feature extraction.

The Marker Fingerprinting Module 210 may be a software and/or hardware subsystem that generates fingerprints based on Feature Matrices produced by the Feature Extraction Module 208 through the Feature Extraction 308 process. In one embodiment, the marker fingerprinting module 210 encodes signal features into a format that is highly conducive to pattern matching, employing a diverse array of encoding and hashing techniques for creating detailed and precise fingerprints, including, but not limited to Hash-Based Audio Matching, Basic Spectral Features Hashing, etc. It is designed with flexibility in mind, allowing the utilization of other methods for creating fingerprints.

One of the key functionalities of this module is the generation of the hash-token table, which serves as an essential data structure within the system. This table, which can be structured as hash: M-dimension values, encodes signal features, facilitates swift lookup and comparison of hash-tokens, enabling the effective matching and identification of signals based on their hashed features. This process is critical for the identification of patterns within large datasets.

The Marker Fingerprinting Module (210) may be designed to support a variety of hashing techniques. This includes, but is not limited to, Basic Spectral Features Hashing, which involves converting the signal into a frequency spectrum using Fast Fourier Transform (FFT) and then hashing the spectral peaks. Other supported methods can encompass Mel-Frequency Cepstral Coefficients (MFCCs) Hashing, Energy-Based Hashing, Scale Invariant Feature Transform (SIFT), a wavelet transform (WT), and/or Locality Sensitive Hashing (LSH). The module is also capable of combining multiple simple features to form a more robust hashing method. This inclusive approach ensures a comprehensive representation of the signal, facilitating accurate pattern identification without the need for intricate models or extensive training datasets.

Additionally, the module can compute local descriptors from the feature matrix to create sub-fingerprints, which assist in accommodating large stretches between entities. This feature adds an extra layer of detail to the fingerprinting process, enhancing the module's capability to handle a wide range of data variances.

During the project's tuning phase, the Marker Fingerprinting Module (210) can store attributes contributing to each hash. This storage is beneficial for subsequent visualization and verification processes, utilizing matrix visualizations or constellation maps as commonly employed in certain hashing algorithms.

As an alternative, advanced machine learning-based hashing techniques could be employed for handling more complex data sets, potentially improving the accuracy and adaptability of the fingerprinting process. Additionally, dynamic hashing techniques that adjust based on feedback from ongoing analyses could be implemented to optimize the fingerprinting process, particularly beneficial in time-sensitive applications.

Upon completion of the hash table creation and storage in Database (160), the system transitions to the Identify Reference Patterns in Target Data (312) process. In this stage, the hash-token information established by the Marker Fingerprinting Module (210) may be utilized for the accurate and efficient detection and identification of patterns.

The Confidence Metrics Module 212 may be a software and/or hardware subsystem that calculates metrics used to understand how well Target entities relate to Reference entities. This module writes these metrics to Datastore 130 or Database 160 or passes them to Pattern Location Module 214, depending on the configuration of the system.

In one embodiment, the Confidence Metrics Module (212) may compute a range of metrics that span continuously across the Search Range of the Target Entity. This continuous analysis across the search range provides a comprehensive overview of the pattern matching process, highlighting general trends and consistencies. Additionally, the module focuses on calculating metrics in relation to peaks identified in the Match Percentage or Match Count histogram. These peaks are considered potential match points between the Reference and Target entities, thus offering a focused and precise means of analyzing specific areas within the data where geological matches are most likely to occur.

The handling of the calculated metrics by the Confidence Metrics Module (212) varies depending on the system's configuration. The module may be equipped to either store these metrics in the Datastore (130) or Database (160) for subsequent retrieval and analysis, or to directly pass them to the Pattern Location Module (214). This flexibility in data handling allows for efficient integration of the metrics into various stages of the pattern identification process.

The Confidence Metrics Module (212) may incorporate advanced statistical methods or machine learning algorithms for more sophisticated analysis, especially beneficial for complex data sets. For scenarios requiring prompt feedback, the module could be modified to support real-time metrics processing and analysis. Furthermore, offering customizable metric frameworks could significantly enhance the module's utility, allowing users to define and compute tailored metrics that align with specific project goals or data characteristics.

The Pattern Location Module 214 may be a software and/or hardware subsystem that identifies and locates reference patterns in target data based on parameters, reference marker information, and fingerprints stored by Marker Fingerprinting Module 210 in Database 160, following constraints provided by Run Preparation Engine 120.

For the Single Target/Single Reference Process, The Pattern Location Module 214 may work in collaboration with the Confidence Metrics Module 212. Its objective is to identify a single marker in a single target entity using information from a single reference entity. The module optionally includes a process loop that addresses scenarios requiring stretch/squeeze adjustments, determining the final match based on the best fit from all evaluations.

The Pattern Location Module 214 may engage in Target and Reference Fingerprint Extraction. In this process, it reads marker fingerprints for both the target entity's search range and the reference entity's search window from Database (160), following the constraints defined in the preparation phase.

The Pattern Location Module 214 may also perform Histogram Generation. The Pattern Location Module 214 may generate a Match Percentage or Match Count histogram by searching for marker fingerprints within the defined search ranges. The histogram aids in identifying candidate peaks, where matching fingerprints are most concentrated, signaling potential match points.

The Confidence Metric Calculation may be another function that may be performed. Utilizing the Confidence Metrics Module (212), the Pattern Location Module (214) calculates several metrics, including Reference Search Window Fingerprint Count, Fingerprint Density, Match Percentage, Match Count, and Average Match Offset. These metrics collectively assist in determining the most likely correct match.

In the Scoring phase, Confidence Metrics Module (212) may evaluate candidate peaks based on set thresholds, considering metrics like Match Percentage, Average Match Offset, and Target Fingerprint Percentage. Peaks that do not meet the threshold criteria may be discarded, and the most promising matches may be passed to the Visualization Engine (170) for further review.

In scenarios involving multiple entities, the module adopts a coordinated approach. It uses Common Fingerprint Sets to identify consistent markers across different entities. This approach aids in maintaining consistency in marker picking among various entities. A spatial picking strategy may be implemented using a k-d tree to identify neighboring wells for each reference well. Common Fingerprint Sets generated from neighboring Reference wells aid in revising marker picks and are extended to Target wells to expand the picked markers away from Reference markers.

The module also quantifies marker distinctiveness by calculating the Secondary Peak Match Percentage, which assists in prioritizing distinctive markers for picking. The picked markers are then reviewed in the Visualization Engine (170), ensuring consistency and reliability in the identified patterns across multiple entities. The process involves iterative adjustments and feedback to improve accuracy, especially during the project's tuning phase.

The Visualization Interface 216 may be a software and/or hardware subsystem that serves as a link between various modules and the Visualization Engine 170. It facilitates the visual representation of outputs and results generated by the Create Visualizations and/or Write Results 314 process. This interface may be designed to pass information to Visualization Engine 170 and on through User Interface 206 and store results for further analysis in Datastore 130 or Database 160.

In one embodiment, the Visualization Interface (216) may be designed with a focus on user-centric customization, allowing it to cater to the varying needs and preferences of different user roles, including analysts and data scientists. This customization feature is pivotal in ensuring that the visualizations meet the specific requirements of users, thereby enhancing the flexibility and usability of the system. The interface facilitates visual confirmation of results, enabling users to visually test the system's outputs and, if necessary, use this visual feedback to compare results and fine-tune the system. This aspect of user-centric customization allows for adjustments in run parameters and provides insights into the impact of these adjustments on the final results.

Furthermore, the Visualization Interface (216) may be developed with industry-specific adaptability in mind. Recognizing the diverse applications across various industries, the interface may be capable of generating visualizations that are tailored to the unique requirements of each industry. For example, in geological applications, the visualizations may include log displays, cross-sections, maps, and other forms of representations pertinent to the field.

Alternatives to the current design of the Visualization Interface (216) may include integrating advanced data visualization tools to offer more dynamic and interactive visual representations. Additionally, incorporating AI-driven visualization techniques may automate the customization process, adjusting visualizations based on user roles and preferences. Another potential enhancement could be the integration of Augmented Reality (AR) and Virtual Reality (VR) capabilities, particularly for industries like geology, where immersive and detailed visual representations could significantly aid in data interpretation.

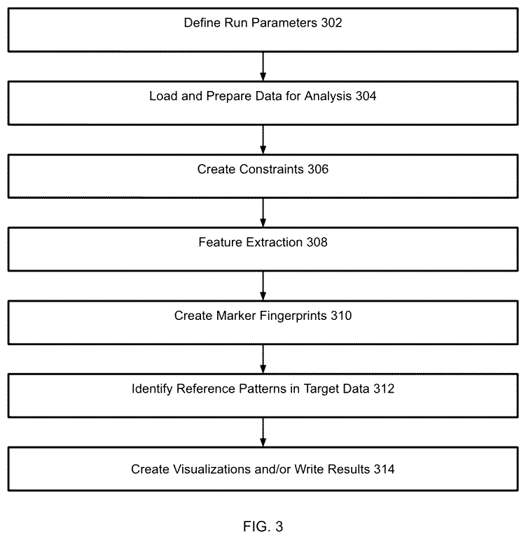

FIG. 3 illustrates, in accordance with an embodiment of the invention, a Pattern Identification Process for executing the inventive concepts described herein. In one embodiment, the process is comprised of the following steps: Define Run Parameters 302, Load and Prepare Data for Analysis 304, Create Constraints 306, Feature Extraction 308, Create Marker Fingerprints 310, Identify Reference Patterns in Target Data 312, and Create Visualizations and/or Write Results 314. This process employs serial or sequential data and markers, such as geologic tops, from Reference entities (e.g., Reference wells), to identify corresponding marker locations in Target entities (e.g., Target wells).

Note that some processes may not be necessary in all cases, and iterations will be useful in some circumstances. The process steps described herein may be performed in association with a system such as that described in FIG. 1 and/or FIG. 2 above or in association with a different system. The process may comprise additional steps, fewer steps, and/or a different order of steps without departing from the scope of the invention as would be apparent to one of ordinary skill in the art.

The Define Run Parameters process 302 may involve reading and reviewing a set of parameters and datastore locations that guide the execution of the subsequent stages. These parameters cover various settings relevant to data handling, feature extraction, pattern matching criteria, and output format preferences. Following the ingestion of these parameters, the system checks them for consistency to ensure smooth operation in later stages.

The Define Run Parameters process 302 may incorporate user-provided parameters, allowing the process to be tailored to specific project needs or user preferences. Interaction with the system is facilitated through a user interface (UI 206), enabling dynamic parameter adjustments and straightforward configuration. Alternatively, the system can function by retrieving predefined settings from a parameter file, offering a more automated approach when direct user interaction is not required.

Once set, these parameters are then passed on to other subprocesses. This is typically done using various methods, including the use of a Datastore (130), which serves as a central point for parameter access and management.

Several alternative methods could be employed to enhance this process. Automated parameter suggestions based on past data analysis or predictive models could aid users in setting up the system. An AI-powered user interface might provide real-time guidance and recommendations, improving user experience and accuracy in parameter selection. Cloud-based parameter management could be another addition, allowing for remote parameter adjustment and collaboration. Furthermore, an adaptive parameter adjustment feature could adjust settings in response to feedback from the ongoing process, ensuring the system remains aligned with the evolving data or project requirements.

In the Load and Prepare Data for Analysis 304, may leverage the parameters and datastore locations established in the earlier Define Run Parameters (302) step. The preparation involves several tasks, each playing a role in refining the data for effective analysis.

Firstly, reference marker information, along with entity location data, when provided, is reformatted and stored. This step may also include assigning unique IDs to all Reference and Target entities and each Marker, facilitating easier tracking and analysis. The serial or sequential data for these entities is then converted into a tabular format, which is more suitable for the analytical tools that will be used later in the process.

The Define Run Parameters process 302 may correct known issues with the data. This may involve addressing discrepancies or errors to ensure the data's accuracy and reliability. Another task is the harmonization of data sampling across different datasets, which is essential for ensuring consistency in the analysis, especially when comparing data from different sources.

Data cleaning procedures may be applied, which include a range of activities such as standardizing attribute mnemonics to maintain consistency in data labels, normalizing data to make value ranges comparable, and synchronizing data series for accuracy, such as applying depth correction in well logs. Additional tasks like selecting relevant data subsets, reformatting data for compatibility, and removing noise and artifacts are also part of this process. Moreover, in cases where deviations in data are significant, such as with deviated well logs, corrections and associated resampling to True Vertical Depth (TVD) or True Stratigraphic Thickness (TST) are performed. For oil and gas wells with high deviation, segmenting the well into overlapping sections may be necessary, with each segment individually corrected. This segmentation and correction process is managed by the Run Preparation Engine (120).

The Define Run Parameters process 302 may comprise data resampling to ensure it aligns with a standard rate, whether in depth, time, or other relevant measurement units.

Alternative approaches in the Define Run Parameters process 302 may comprise the use of automated systems for data quality assessment, which can suggest specific cleaning or correction procedures. Advanced noise reduction techniques could be employed for handling complex data artifacts. Machine learning might also be utilized for automating the standardization and normalization of large and diverse datasets.

In the Marker Fingerprinting approach, the Create Constraints 306, may involve setting up specific constraints within which the system searches for matches within the Target entity, defines markers that cannot cross, sequence-based constraints, attribute-based constraints, proximity constraints, dynamic adjustment constraints, correlation-based constraints, directional constraints, multi-marker relationship constraints, error margin constraints, and environmental constraints, and other constraints to help avoid false positives. While not always required, applying these constraints can significantly reduce the time spent on searches, particularly in instances where distinguishing between similar patterns is challenging, like repeated choruses in music or geological well tops.

Create Constraints 306 may identify suitable constraints that can be applied to the search range for a particular marker within a Target entity. In geological contexts, these constraints are often used to maintain stratigraphic order and to respect the present-day structural context. For example, in geological well picking scenarios, a grid of cross-sections is created over the area of interest using Reference wells and marker information. This grid forms what is known as a Constraint Grid for each geological horizon. The Constraint Grid then helps define the Search Region on the Target well, typically setting it within an interval between the next-younger and next-older markers or some distance above and below the Constraint Grid. This method is effective in minimizing the occurrence of false positives, which can arise due to similar geological formations produced by repeated geological processes.

Once these constraints are established, the information regarding the upper and lower limits of the Search Region may be conveyed to the subsequent subprocesses. This transfer of information can be accomplished either directly or through tools like the Datastore 130 or Database 160, depending on how the system is configured.

The constraint grids may be updated with markers that emerge from the search process before proceeding to evaluate the next set of Target wells. This iterative approach allows for continuous refinement of the search parameters.

Additionally, the Create Constraints 306 may also address how much the interval of interest might change from the Reference to the Target entity, particularly in geological settings where intervals can vary significantly. To accommodate these variations, new datasets may be created and resampled to the standard interval, accounting for the maximum and minimum stretching of the intervals. These datasets are then processed through the search, either directly or using the Datastore 130 or Database 160.

Create Constraints 306 may include automated generation of constraints based on historical data analysis or predictive models, dynamic adjustment of constraints in response to ongoing analysis results, and the use of machine learning algorithms to optimize constraint settings. These alternative methods can provide additional flexibility and efficiency in handling complex scenarios in geological settings or other fields where the Marker Fingerprinting approach is applied.

The Feature Extraction 308 in the Marker Fingerprinting approach, may transform the data from each reference or target entity, like a geological well, into a format ready for hash-token representation. This is achieved using the modules which convert multi or single attribute data into a single M×N matrix. This matrix serves as the foundation for further processing in a fingerprinting module.

There are three primary methods employed in this module: Flattening, Music Conversion, and Direct Matrix Generation. These methods can be used separately or in combination, depending on the nature of the data and the specific needs of the analysis. Regardless of the method, the process starts by retrieving cleaned data for each entity from a datastore.

In the Flattening Method, multi-attribute data is merged by interleaving elements of each data series or sequence. For each row (1-M), elements of columns (1-N) are written sequentially, resulting in a one-dimensional matrix M*J long, where J represents the number of columns for the entity. This approach creates a flat, one-dimensional array data series encapsulating all matrix elements in a row-wise manner, which is particularly useful in scenarios where a non-hierarchical, linear data format is advantageous. Single-attribute entities are processed without modification in this step.

The data, once flattened, can be further processed. It can either be transformed into a Feature Matrix using its native units or converted into a time representation. The latter is beneficial for leveraging tools designed for audio signal manipulation and visualization. For instance, in the example of a geological well log with three log curves, the curves are flattened and potentially transformed to time using standard audio formats like MP3 or WAV. This transformation is done using a time sampling interval (TSI), correlating the resulting time to depth or other relevant units.

To illustrate the process, consider a geological well log as an example. In this scenario, the entity is a well with three log curves recorded at ½-foot intervals-let's call them Curve A, B, and C. These curves are flattened to create a data series that interleaves them, resulting in a one-dimensional series that is three times as long as the original curves, Series D.

Transforming Series D to time is often facilitated by utilizing standard audio formats like MP3 or WAV, compatible with conventional tools. This process involves a transformation using a time sampling interval (TSI), and creates Series E. The resulting time from this conversion correlates to depth (or other units in the general case) through the equation:

$$depth = ( time \times DSI \times ( TSI / J ) ) + trimmed\_log \_depth$$

Where:
depth is the depth of an element in the series.
time is the time of an element in the series.
DSI is the depth sampling interval, set at ½-foot in this case.
TSI is the time sampling interval; for this example, 64 samples per second is used.
J is the number of curves or attributes, set at 3 in this case.
trimmed_log_depth for this example is 1,000 ft., indicating that the first thousand feet do not need to be evaluated, and the data starts after that depth.

Utilizing these values results in the equation:

$$depth = ( time \times 0.5 \times ( 64 / 3 ) ) + 1000$$

At this point using the Flattening method, there is either a Series D in native units or a Series E in time, both representing the data as a one-dimensional series. The discussion about transforming these series into a Feature Matrix will primarily center around time, although it is feasible to perform the transformation in native units. It's important to note a trade-off exists, particularly concerning the use of audio tools and dataset size. Native datasets, such as well logs in depth, often comprise considerably fewer samples than when transformed to WAV or MP3 format, since these series are often converted to the time domain at 64 Hz or something similar, then upsampled to 8,000 Hz or more while simultaneously constructing a sinusoidal signal. This approach can be important for generating data suitable for Fourier Transforms, enabling some search algorithms to function as intended. The upsampling, coupled with the sinusoidal signal, ensures the availability of sufficient data to construct meaningful fingerprints in frequency space for certain algorithms.

The Feature Matrix Generation Process involves transforming the data series into a Feature Matrix. Common approaches for this transformation include creating a spectrogram using methods like the Short-Time Fourier Transform (STFT), Continuous Wavelet Transform (CWT), or Gabor Transform (GT). Each method offers unique benefits for analyzing signals, with CWT being particularly effective for non-stationary or multi-scale signals, and GT for signals with non-stationary and localized features.

The Flattening method combined with these transformations helps in reducing susceptibility to amplitude scaling issues in subsequent fingerprinting processes. After generating the Feature Matrix, the data is directed either to Datastore (130), Database (160), or the Marker Fingerprinting Module (210). This direction depends on the system's configuration and optimization.

In certain cases, an accompanying data series is needed to highlight more energetic points in the signal. This might involve computing the Hilbert Envelope of the signal or the L4 norm, which are then passed to the Marker Fingerprinting Module (210) or stored.

The music conversion method: this method takes multi or single attribute data for an entity and converts the amplitudes into musical pitches, which are then transformed into audio. Each attribute in the dataset is assigned to a different virtual musical instrument, aiding in differentiation in the Feature Matrix. This method retains the shape of the original data's amplitudes, making it essential to ensure careful data preparation for seamless matching of datasets. The quantization of amplitudes during the conversion to pitch serves as a measure to partially mitigate potential amplitude issues. Sets of consecutive samples can be mapped to musical notes of different lengths. For example, a set of consecutive samples falling into a same bin measuring about a half-foot of depth in length can be mapped to one sixteenth note.

Each reference and target dataset is passed into this process as an M×J matrix, where J is the number of attributes. Each attribute is processed separately and then the audio tracks are combined as musical instruments are assigned to each attribute and audio is generated.

The process starts by scaling an attribute to fit the use case, keeping in mind that this process at most will provide 128 bins for values, so will reduce dynamic range. That said, most important markers still show up using this range, and the range compression also helps reduce reliance on data cleaning.

In some cases, it may be appropriate to use an even shorter range so that attributes occupy different portions of the resulting Feature Matrix, but that is generally not necessary.

Value to Pitch Process: Most commonly, a range for each attribute would be determined by examining all target and reference datasets to see what minimum and maximum value needs to be preserved. The minimum value would be called “bmval” and the log of that value is “baseval”. Baseval will be assigned to Musical Instrument Digital Interface (MIDI) number 0.

Take the log of each sample and subtract it from the log value assigned to MIDI zero. Call that variable “delatalog”.

Divide that difference by log (2)/12, which is the logarithmic interval of a half-step, with log (2) being one octave. Call that variable “ahsval”.

Remember that the highest value should not be assigned to a MIDI value greater than 127, so calculate a value, hsmult, to scale the range properly. Hsmult is the ratio of 127 to (log (max value-min value)/ahsval

The half steps between baseval and the element's pitch are deltalog. To determine the MIDI value, midipitch, use this equation:

midipitch=bmpitch+round((deltalog*hsmult)/ahsval)

This process uses the full MIDI range, but some may want to stick to the piano range, which would be from MIDI number 21 to 108.

Note Duration Process: For this process a parameter will be passed in determining note duration to use for each sample interval. For example, a sixteenth note or a quarter note could be selected. This along with the starting depth will determine the time-depth relationship.

Determine whether to sustain notes where the sample values stay within a note for multiple samples or to cut off the note after the first sample. Cutting off the tone can be useful in some situations to create greater distinctiveness in the resulting audio track.

MIDI to Conversion Process: Each attribute is converted to MIDI using above information and selecting an appropriate synthetic instrument for each log curve, being careful that the synthetic instruments do not sound too much alike in the extremes of their ranges. The results are combined into a single output, Series F in time, representing the data as a one-dimensional series in WAV, MP3, or other suitable audio format.

Series F now requires transformation into a Feature Matrix via Feature Matrix Generation Process, as described in the section with that title under the The Flattening Method.

The Direct Matrix Generation Method creates a Feature Matrix in a repeatable manner, suitable for all reference and target datasets. This method involves converting an input M×H array into an M×N matrix using element values as indices. This general approach can also approximate a Feature Matrix as though the Music Conversion method were used, by processing each attribute independently and using two-dimensional filters appropriate for various instruments.

This process takes an input M×H array, loop through all H columns using the element values as indices to determine the bin to use in the output M×N matrix. Note that this will take the dataset from something like 3-10 columns wide to one that could be 256 wide, but with a shallower bit depth, as low as 1-bit.

Spectrogram matrices are often used for audio fingerprinting and commonly use 1024 frequency bins, though the exact number of frequency bins is determined by factors such as the sampling rate, the duration of the signal, and the desired frequency resolution.

Many applications like correlating well logs do not require that resolution. The number of bins to use in the system is a balance between a higher number of bins for higher dynamic range and greater detail, and a lower number of bins to allow quantization to compensate for geological changes and measurement noise and make mildly varying values map to the same element in the matrix.

Scaling: For scaling, going from column 1-H for each column of the matrix, the minimum and maximum useful values across all target and reference datasets for that attribute is determined and scaled to fit the number of bins, N, desired for Marker Fingerprinting Module 210, for this example we'll use 256 bins.

Bit Depth: To save space, the elements do not need to be the same bit depth as the original values. The original value relationships are preserved by mapping value to bin number, so the new matrix values preserve the original information by a simple 1-bit representation. That leaves a matrix that is mostly zero and only 1s where the bin maps to the value.

However, it can be useful to add information to the dataset to encode information about which attributes are used, for example, and to help with selecting thresholds that can be used in Marker Fingerprinting Module 210. For this purpose, a bit depth consistent with the maximum number of attributes can be used, as well as some space in case other filters are needed. A 5-bit representation which allows for 32 values is often sufficient for those purposes, but more may be desired in some applications. The encoding of attributes can be done for the tuning stage then returned to a lower bit depth once the correct attributes have been determined.

Once scaling and bit depth have been determined, each of the reference and target datasets which are M×H in size are passed into the system and converted to an M×N matrix. In one embodiment the values of each element are assigned to a bin in the output matrix using the value as an index and quantizing using the appropriate scaling. The output value will map to the attribute. For example, Attribute 2 is recorded in Column 2 of the M×H matrix, and the element in the 10th row is 10. Scaling determined that the lowest value is zero and the highest is 256. Its value will be scaled to map to the 10th bin in the output Feature M×N matrix and the output element value will be 2 to record the attribute for use in Marker Fingerprinting Module 210.

In some cases it may be useful to also convert features like Zero Crossing Rate (ZCR) directly to a matrix in this manner and either added to the final or passed as a second matrix to be converted to hashes separately and added to the hash table for search.

This approach in the most general sense can provide an alternate means of approximating a Feature Matrix as though the Music Conversion method had been used. To achieve that requires processing each attribute independently and convolving their initial matrix with two-dimensional filters that include harmonics appropriate for various instruments and mapping to a full 1024 bin array. The matrices can then be summed to provide a complete spectrogram of the attributes. This approach does not allow Marker Fingerprinting Module 210 to turn on and off various attributes, but once a set of attributes is determined that functionality will not be necessary. Additional information like paleontological data can be included by converting either counts or presence/absence of a given paleo marker to a value and adding it to a bin of the matrix.

Depending on the method used, the Feature Extraction process can offer different advantages. For instance, the Flattening method using transformations like STFT can reduce susceptibility to amplitude scaling issues in subsequent fingerprinting processes. The Music Conversion method allows for a creative representation of the data, converting it into audio format for further analysis. The Direct Matrix Generation method provides a more straightforward approach to creating a Feature Matrix without the need for additional transformations.

After generating the Feature Matrix, the data may be stored in a database, or passed directly to another module for identification. This step is flexible and varies based on the deployment of the system. The Feature Extraction process 308 may provide a range of methods to transform complex data into a format conducive for detailed analysis in the Marker Fingerprinting approach. Each method offers unique ways to handle the data, ensuring that the system can adapt to various types of data inputs and analysis requirements.

The Create Marker Fingerprints 310 in the Marker Fingerprinting approach, may formulate fingerprints from the Feature Matrices. These matrices are derived from the data of reference or target entities, such as geological wells, and are produced by the a Feature Extraction Module through the Feature Extraction (308) process. The Create Marker Fingerprints 310 may create a digital token (e.g., hash-token) table that encodes signal features, enabling the system to later identify and locate corresponding patterns between Reference and Target entities, as detailed in the Identify Reference Patterns in Target Data (312) process. The examples provided in the Identify Reference Patterns in Target Data 312 process are based on a technique used in audio fingerprinting called Hash-Based Audio Matching, but other methods may be used. For example, digital tokens (e.g., hash tokens) can be generated from the Feature Matrix without converting the Feature Matrix into an audio file. For example, hashes can be generated using non-audio feature matrices, using methods such as spectral peak detection, zero-crossing rate (ZCR), or energy-based hashing. This process creates compact and query-efficient representations without relying on audio

The Create Marker Fingerprints 310 may read a Feature Matrix along with associated parameters and then generates a hash-token table. This table is stored in a database and comprises hash: M-dimension values that represent the signal features. The hash-token table serves as an efficient data structure for quick lookup and comparison of hash-tokens, which is essential for matching and identifying signals based on their hashed features.

An additional aspect of this process, particularly useful during the tuning phase of a project, is the storage of attributes that contribute to each hash. This allows for later visualization and verification against the original Feature Matrix or on a constellation map, a common practice with some hashing algorithms.

Several hashing options are employed in this process, including Basic Spectral Features Hashing, Mel-Frequency Cepstral Coefficients (MFCCs) Hashing, Energy-Based Hashing, and Combining Multiple Simple Features. Each of these methods offers a unique approach to converting signal features into hash-tokens:

Basic Spectral Features Hashing utilizes FFT to convert the signal into a frequency spectrum and then hashes the spectral peaks.

MFCCs Hashing provides a compact representation of the signal spectrum for hashing.

Energy-Based Hashing calculates energy in different frequency bands of the signal for hashing.

Combining Multiple Simple Features involves combining features like ZCR, energy, and spectral peaks for a more comprehensive hashing method.

Alternative hashing techniques might include advanced methods suitable for more complex datasets or specific analysis requirements. Customized hashing algorithms could also be developed to cater to particular types of data or to optimize the accuracy and efficiency of the pattern matching process.

The Identify Reference Patterns in Target Data 312 process uses Pattern Location Module 214 to identify corresponding reference patterns in the target data. A pattern Location Module may identify and locate reference patterns in target data using parameters and reference marker information prepared in Run Preparation Engine, fingerprints stored by Marker Fingerprinting Module in a database, according to constraints supplied by a Run Preparation Engine.

Run Preparation Engine 120 provides a table each row of which contains the Entity ID, Marker ID, Search Range Top, and Search Range Bottom for all target entities. It also provides the list of Target Entity IDs and Marker IDs to be searched from each Reference Entity ID along with the stretch/squeeze range to be used for Targets to be searched by each Reference. This data will be used to determine the search range for each marker. Constraints are not required in all instances but can save significant search time by avoiding search far from where a match might be found. They are also helpful because in some cases geologic processes produce formations in similar ways repeatedly, so vertical geological changes can be on the order of spatial changes, making false positives possible.

This module is designed to handle a range of use cases from simply picking a single marker in a single reference entity, to picking multiple markers in multiple reference entities in many target entities.

Single Target/Single Reference Process: In the simplest case, the Pattern Location Module 214 works with the Confidence Metrics Module 212 to identify a single marker on a single target entity with a single reference entity.

If stretch/squeeze is required, this process will be a loop incrementing the stretch/squeeze range and reading fingerprints appropriate for the stretch/squeeze specified. The final match will be determined based on the best fit from all passes.

Target Entity Marker Fingerprint Extraction: Pattern Location Module 214 reads the marker fingerprints for the Search Range for the Target Entity from Database 160. That Search Range is limited by constraints, when used.

Reference Entity Marker Fingerprint Extraction: Pattern Location Module 214 proceeds to extract fingerprints for the Search Window across the M dimension (which could represent depth, time, distance, or sequence number, depending on the context) centered on Marker 1 in Reference Entity 1 from Database 160, if the Reference Marker Location in Window specifies 50%. In cases where markers are expected to occur beneath missing data because of unconformities, for example, the Reference Marker Location in Window may be at the top of the Window, 0%. Other situations may require the Marker to be located anywhere in the window. Alternatively this window of fingerprints can be generated directly from original data stored in Datastore 130, but this is more expensive and induces noise due to the short window length when transforms are used to generate the Feature Matrix.

Histogram Generation: Pattern Location Module 214 next searches for all marker fingerprints in the Reference Search Window with the list of marker fingerprints within the Target Search Range. Similar to well-known audio fingerprinting techniques, the marker fingerprints generated by Marker Fingerprinting Module 210 are generally in simple hash: M format, where M is generally time or depth when dealing with well logs. The module loops through each hash from the Reference Search Window and determines all of the places that the hash matches within the Target Search Range and calculates the M dimension offset by subtracting M of the Reference from M of the Target. Each time a match is found, it adds a count to the M dimension offset bin associated with that offset, and when all searches are completed, a histogram can be created showing where the number of matching marker fingerprints are highest. Peaks of the histogram where counts are highest are candidates for a match, since matching fingerprints should occur with the same offset and in the same relative M dimension sequence.

Confidence Metric Calculation: Confidence Metric Module 212 then creates a number of metrics that together to help determine which of the candidate peaks is most likely to be the correct match. The first metric is the Reference Search Window Fingerprint Count, which is a count of all the marker fingerprints in the Reference Search Window. The module has access to the histogram data which is the Matching Fingerprint Count Histogram by M dimension offset, which is then adjusted or converted to the desired output M dimension for the Target entity, such as depth for well logs.

Next the Fingerprint Density is calculated for the Target Search Range by calculating 100*the count in a bin/bin width in the M dimension. This provides information on how many fingerprints there are per 100 units in the M dimension to assist with determining whether there are too many or too few fingerprints being generated with a given set of run parameters.

The Match Percentage is the ratio of Matching Fingerprints to the Reference Window Fingerprint Count, This expresses how many matches are being found between Reference and Target wells in the bin and should be 100% when self-picking the reference top and well.

Average Match Offset is used to determine the likelihood that some signal in the Target is missing in the vicinity of a candidate match. For example, in well logs, section can be missing due to faulting or unconformities within the match window. If enough section is missing it is unlikely the match will be found at all, but in some cases only some section is missing above or below the marker. For each peak in the Match Percentage histogram, the matched marker fingerprints in the peak bin have their M dimension values averaged and subtracted from the M dimension calculated by the bin center minus half of the window length. This provides a Target M Index.

The same is done for the Reference Search Window to calculate the Reference M Index. The Average Match Offset is then calculated by subtracting the Target M Index from the Reference M Index. When the Average Match Offset is positive, then there is a chance that the Target is missing section/signal high in the Target window. If the Average Match Offset is negative, then there is a chance that the Target is missing section or signal low in the Target window. Note that the marker location will still be correct as long as the missing section does not fall in the window where the marker is located. A marker centered in the window will be properly located if some section is missing at the top of the window but will be incorrect if the marker is slated to be picked at the top of the window. It's generally safest to use a Reference Marker Location in Window of 50% for that reason, or at least 10% so that some section can be missing at the top of the target window and not affect the marker location.

Target Fingerprint Percentage is calculated with a window the same length as the Reference Search Window. It is located relative to a Matching Fingerprint Count Histogram bin according to the Reference Marker Location in Window. When “Reference Marker Location in Window” is 50%, then the window for this calculation is centered on the bin. Using that window length, a count is made of marker fingerprints for each M dimension unit and a ratio is calculated of that value to the number of fingerprints in the Reference Search Window. The goal is to determine whether the Target is richer or poorer in fingerprints than the Reference at any given M dimension location.

Special metrics may be useful in some situations to discard candidate peaks that look similar by fingerprints but are different in power or frequency. In those instances, averages of measures like Hilbert Envelope, Hilbert Instantaneous Frequency, or Zero Crossing Rate (ZCR) may be computed over the Reference Search Window and compared to those same metrics over the window surrounding candidate Target peaks and passed for consideration in the scoring process.

Once Confidence Metric Module 212 has completed calculations, it determines the top X peaks, where X is an input parameter, in the Match Percentage histogram and returns confidence metrics on those peaks to Pattern Location Module 214.

Scoring: Pattern Location Module 214 then evaluates the candidate peaks and evaluates them per thresholds set in the initial parameters. The most important three metrics for consideration are the Match Percentage, the Average Match Offset, and Target Fingerprint Percentage. In the tuning phase of a project candidate matches should show these measurements visually on the signal for several examples to determine thresholds. In one embodiment, peaks that fall below any of the threshold values are discarded. At this point very likely a single match has been found and passed on to Visualization Engine 170. If not, then the candidate matches are typically ranked by Match Percentage and passed on to Visualization Engine 170, where the three metrics will be annotated on the output and the end user flagged to consider the result and a change possible of parameters.

In some cases, it may be useful to iterate on the Marker Fingerprinting approach using different parameters in order to first allow very general matches and then to refine them to tighter tolerances once searching a smaller range. It may also be useful to pair the Marker Fingerprinting approach with a totally different approach to marker identification such as cross correlation, dynamic warping, or a convolutional neural network for similar reasons.

Multiple Target/Multiple Reference Process: In many instances a coordinated approach must be taken to picking many target entities with multiple reference entities. This explanation will primarily focus on a well log correlation example, but a similar approach can work in other situations.

Common Fingerprint Sets provide a new approach to picking multiple entities that addresses a problem: when an analyst determines a marker based on the surrounding signal, they are excellent at identifying the pattern, but repeatability is challenging. Other analysts will often pick the same markers at slightly different locations. This approach often does not define what characteristics identify the marker, adding to the challenge.

Marker Fingerprinting addresses the challenge in a unique way, because each marker in the Reference set is described by a set of fingerprints which are hashes tied to a particular M-dimension location in the series. When considering well log correlation, these hashes are tied to depth or time, depending on the approach being used.

Consider two Reference entities, 1 and 2, and their fingerprints for Marker Alpha. The process starts by using Reference Entity 1 to pick Marker Alpha in Reference Entity 2. Assuming those picks meet threshold criteria, then the fingerprints that are in the peak of the histogram and made the pick are common to both entities and are in corresponding M-dimension order and will be called CF_MA_E1-E2 in this example. The same process is repeated using Reference Entity 2 to pick Marker Alpha in Reference Entity 1 to generate CF_MA_E2-E1. The reason the fingerprint set using Entity 2 to pick Entity 1 is not the same as using Entity 1 to pick Entity 2 is that the reference markers are not necessarily in a consistent location relative to the signal, so the windows will vary a bit in what fingerprints are included.

These fingerprint sets are then combined to determine the set of fingerprints uniquely common to both entities. For brevity, the fingerprints themselves are represented by single letters in this example. CF_MA_E1-E2 has fingerprints in order by M-dimension of B, M, C, F, J, D, E. CF_MA_E2-E1 has fingerprints in order by M-dimension of B, S, C, F, T, D, E. They then have common fingerprints of B, C, F, D, E. A new Common Fingerprint Set is then defined, Common Fingerprint Set Marker Alpha Reference 1 and 2 (CFS_MA_E1-E2). This can then be used to pick both Reference Entity 1 and Reference Entity 2 to get an adjusted location of Marker Alpha that is consistent with the common fingerprints of both entities.

For Reference Entity 1, a comparison is made at this point of the initial Reference Entity 1—Marker Alpha to Marker Alpha as picked by the initial Reference Entity 2—Marker Alpha and to the new marker location as determined using CFS_MA_E1-E2. These three values should be close to one another, with CFS_MA_E1-E2 generally between the two, and the same will hold for Reference Entity 2. This same process can be extended to include several different reference entities in an area if desired.

The default computation for the new marker location for wells typically involves averaging the marker locations within the reference window contributed by all relevant entities. Subsequently, a new Reference Marker Location in Window is calculated relative to the window defined by the Common Fingerprint Set. To illustrate, if the Reference Marker Location in Window was initially specified as 50% during the first pass, adjustments may occur after establishing the Common Fingerprint Set. If the window shifts upward relative to the average marker location, subsequent picks based on the Common Fingerprint Set will incorporate the revised Reference Marker Location in Window value, utilizing the Common Fingerprint Set for making refined picks.

Oftentimes large numbers of entities need to be picked and still use the Common Fingerprint Sets. As an example, consider a cross section that runs from a thick part of the basin to a thinner area. The first test is whether a single common fingerprint set can be used to pick the entire cross section and meet confidence metric thresholds. If so, that common fingerprint set should be used to pick all wells.

If not, then going across the cross section, create common fingerprint sets for each pair of wells. The wells/entities at the ends of the cross section will be picked with the common fingerprint sets defined with their adjacent wells. Wells interior to the cross section are each picked by creating common fingerprint supersets that combine the common fingerprint sets on either side of them. That allows the definition of a pick to evolve down the cross section. If at any point common fingerprint sets fail to make picks that meet the thresholds, then feedback must be provided to the analyst.

Common Fingerprint Sets also provide a means for creating new infill markers between reference markers. Since each Common Fingerprint Set is created from matching and corresponding Marker Fingerprints, each of those corresponding and matching fingerprints can become an infill marker relating all of these wells that contribute to the Common Fingerprint Set. These can also be carried more broadly when used as reference markers themselves.

The picks using all approaches should be visualized for consistency. Simple averages of various picks may work well, but averages are not based on any objective log characteristics so should be avoided whenever practical.

Marker Fingerprints may also be used to closely relate markers in reservoir models to well logs. That relationship can be achieved by creating high-resolution synthetic wells logs at several places in the reservoir model near real wells and passing along the marker depths. These markers can then be picked in the real wells to make sure that those markers are truly related to geological interfaces in the reservoir model. Common Fingerprint Sets can be used to carry those picks away from the reservoir model and maintain consistency with it.

Marker Distinctiveness: Marker Fingerprinting may help by quantifying marker distinctiveness. To measure distinctiveness, each Reference Entity selects each marker from the initial reference set and calculates the Match Percentage based on the second-highest peak in the histogram. When a marker picks itself during this process, the match percentage is 100%. The match percentage can be relatively high for another marker if it bears a resemblance. Using this approach, the Secondary Peak Match Percentage can be determined in all Reference Entities and for all markers, and then averaged for each marker. The marker with the lowest average Secondary Peak Match Percentage is a good candidate for the most distinctive marker in the area.

Spatial Picking Strategy: Picking large areas requires techniques for identifying nearby wells. A k-d tree can be implemented using analyst-provided x, y, or latitude and longitude locations for each Reference and Target well. This example embodiment will discuss picking multiple target entities from multiple reference entities for one marker.

For each Reference well, identify its neighbors within a specified distance using the k-d tree. Get the marker fingerprints for each Reference well for the Search Window of the marker to be picked.

For each Reference well that has greater than n neighboring Reference wells with the desired marker, create a Common Fingerprint Set from those neighboring Reference wells and use that to create a revised marker pick for each Reference well. If a Common Fingerprint Set that meets threshold criteria cannot be created for that well, then that well is removed from the Reference set and a flag is set to alert the analyst of potential problems with that well.

If the Common Fingerprint Set marker location is within some limit of the average marker location as picked by neighboring wells, then that marker becomes the new marker location for that well. In all cases, a list of initial marker locations, revised marker locations, and confidence metrics will be passed to Visualization Engine 170 to be reviewed by the analyst.

Once the Reference well dataset has been updated using Marker Fingerprinting, the process can be extended to Target wells using a similar process of locating neighboring Reference wells within a given distance. This will extend the picked markers away from the Reference markers out to the distance specified. Picking can continue further away from Reference wells if desired, by using newly picked Target wells having markers with Match Percentage above a given threshold becoming Level 2 Reference Wells and used to extend outward to more Target wells. This process can be continued until markers no longer can be picked within tolerance using Marker Fingerprinting.

Many details of the approach can be changed, but the key is to use Common Fingerprint Sets whenever practical in place of averages or other statistics for combining picks from many wells.

The Multiple Target/Multiple Reference Process this process will often be started with the most distinctive marker and then loop through markers above and below it.

Upon completion of these steps, the system is equipped to accurately identify reference patterns in target data, enabling a detailed understanding of the patterns present across various entities. This process is adaptable, catering to simple scenarios as well as handling more complex cases, making it a versatile component of the Marker Fingerprinting approach.

The Create Visualizations and/or Write Results process, identified as step 314 in the Marker Fingerprinting approach, is focused on generating visual outputs and storing results for subsequent analysis and interpretation. This step is carried out through the User Interface (206) and draws upon the outputs generated by the Pattern Identification Engine (140). It helps translate the complex data processed by the system into visual representations that are both informative and accessible to various users, including analysts and data scientists.

The process involves creating a range of visualizations that are customized to meet the specific requirements of different industries. For geological applications, typical visualizations include log displays for individual wells, cross-sections, and maps. The specific types of visualizations produced include per-well curves, graphs showing match percentage versus depth, target fingerprint percentages, average match offsets, combined curves generated from the Feature Matrix, and constellation maps if used by the hashing algorithm. Additionally, marker fingerprints, log curves used to create combined curves, markers picked by the system, and reference markers are visualized. Cross-sections and maps can display multiple wells with combinations of metrics and curves, providing a comprehensive view of the data.

An important feature of these visualizations is their scalability, allowing users to examine details at close range or to assess marker locations over broader areas. This scalability is helpful for ensuring that the visualizations are effective in both tuning the system for specific applications and in rapidly validating results.

Alternative approaches to enhance these visualizations may include the implementation of interactive visualization tools, which would allow users to engage more deeply with the data by manipulating data points or adjusting parameters. Machine learning-enhanced visualizations could offer predictive insights or highlight areas of interest by analyzing patterns and trends within the data. Customized visualization dashboards could also be an option, providing users the flexibility to select and arrange various types of visualizations to suit their individual needs.

### Hardware Architecture

Generally, the techniques disclosed herein may be implemented on hardware or a combination of software and hardware. For example, they may be implemented in an operating system kernel, in a separate user process, in a library package bound into network applications, on a specially constructed machine, on an application-specific integrated circuit (ASIC), or on a network interface card.

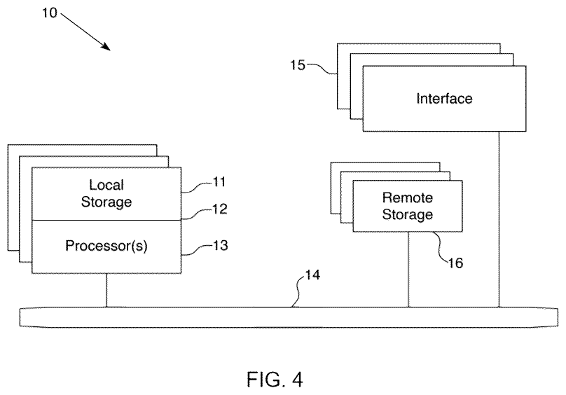

Software/hardware hybrid implementations of at least some of the embodiments disclosed herein may be implemented on a programmable network-resident machine (which should be understood to include intermittently connected network-aware machines) selectively activated or reconfigured by a computer program stored in memory. Such network devices may have multiple network interfaces that may be configured or designed to utilize different types of network communication protocols. A general architecture for some of these machines may be described herein in order to illustrate one or more exemplary means by which a given unit of functionality may be implemented. According to specific embodiments, at least some of the features or functionalities of the various embodiments disclosed herein may be implemented on one or more general-purpose computers associated with one or more networks, such as for example an end-user computer system, a client computer, a network server or other server system, a mobile computing device (e.g., tablet computing device, mobile phone, smartphone, laptop, or other appropriate computing device), a consumer electronic device, a music player, or any other suitable electronic device, router, switch, or other suitable device, or any combination thereof. In at least some embodiments, at least some of the features or functionalities of the various embodiments disclosed herein may be implemented in one or more virtualized computing environments (e.g., network computing clouds, virtual machines hosted on one or more physical computing machines, or other appropriate virtual environments). Any of the above-mentioned systems, units, modules, engines, controllers, components, process steps or the like may be and/or comprise hardware and/or software as described herein. For example, the systems, engines, and subcomponents described herein may be and/or comprise computing hardware and/or software as described herein in association with FIGS. 4-7. Furthermore, any of the above mentioned systems, units, modules, engines, controllers, components, interfaces or the like may use and/or comprise an application programming interface (API) for communicating with other systems units, modules, engines, controllers, components, interfaces or the like for obtaining and/or providing data or information.

Referring now to FIG. 4, there is shown a block diagram depicting an exemplary computing device 10 suitable for implementing at least a portion of the features or functionalities disclosed herein. Computing device 10 may be, for example, any one of the computing machines listed in the previous paragraph, or indeed any other electronic device capable of executing software- or hardware-based instructions according to one or more programs stored in memory. Computing device 10 may be configured to communicate with a plurality of other computing devices, such as clients or servers, over communications networks such as a wide area network a metropolitan area network, a local area network, a wireless network, the Internet, or any other network, using known protocols for such communication, whether wireless or wired.

In one aspect, computing device 10 includes one or more central processing units (CPU) 12, one or more interfaces 15, and one or more busses 14 (such as a peripheral component interconnect (PCI) bus). When acting under the control of appropriate software or firmware, CPU 12 may be responsible for implementing specific functions associated with the functions of a specifically configured computing device or machine. For example, in at least one aspect, a computing device 10 may be configured or designed to function as a server system utilizing CPU 12, local memory 11 and/or remote memory 16, and interface(s) 15. In at least one aspect, CPU 12 may be caused to perform one or more of the different types of functions and/or operations under the control of software modules or components, which for example, may include an operating system and any appropriate applications software, drivers, and the like.

CPU 12 may include one or more processors 13 such as, for example, a processor from one of the Intel, ARM, Qualcomm, and AMD families of microprocessors. In some embodiments, processors 13 may include specially designed hardware such as application-specific integrated circuits (ASICs), electrically erasable programmable read-only memories (EEPROMs), field-programmable gate arrays (FPGAs), and so forth, for controlling operations of computing device 10. In a particular aspect, a local memory 11 (such as non-volatile random-access memory (RAM) and/or read-only memory (ROM), including for example one or more levels of cached memory) may also form part of CPU 12. However, there are many different ways in which memory may be coupled to system 10. Memory 11 may be used for a variety of purposes such as, for example, caching and/or storing data, programming instructions, and the like. It should be further appreciated that CPU 12 may be one of a variety of system-on-a-chip (SOC) type hardware that may include additional hardware such as memory or graphics processing chips, graphics processing units (GPUs) such as a QUALCOMM SNAPDRAGON™ or SAMSUNG EXYNOS™ CPU as are becoming increasingly common in the art, such as for use in mobile devices or integrated devices.

As used herein, the term “processor” is not limited merely to those integrated circuits referred to in the art as a processor, a mobile processor, or a microprocessor, but broadly refers to a microcontroller, a microcomputer, a programmable logic controller, an application-specific integrated circuit, and any other programmable circuit.

In one aspect, interfaces 15 are provided as network interface cards (NICs). Generally, NICs control the sending and receiving of data packets over a computer network; other types of interfaces 15 may for example support other peripherals used with computing device 10. Among the interfaces that may be provided are Ethernet interfaces, frame relay interfaces, cable interfaces, DSL interfaces, token ring interfaces, graphics interfaces, and the like. In addition, various types of interfaces may be provided such as, for example, universal serial bus (USB), Serial, Ethernet, FIREWIRE™, THUNDERBOLT™, PCI, parallel, radio frequency (RF), BLUETOOTH™, near-field communications (e.g., using near-field magnetics), 802.11 (WiFi), frame relay, TCP/IP, ISDN, fast Ethernet interfaces, Gigabit Ethernet interfaces, Serial ATA (SATA) or external SATA (ESATA) interfaces, high-definition multimedia interface (HDMI), digital visual interface (DVI), analog or digital audio interfaces, asynchronous transfer mode (ATM) interfaces, high-speed serial interface (HSSI) interfaces, Point of Sale (POS) interfaces, fiber data distributed interfaces (FDDIs), and the like. Generally, such interfaces 15 may include physical ports appropriate for communication with appropriate media. In some cases, they may also include an independent processor (such as a dedicated audio or video processor, as is common in the art for high-fidelity A/V hardware interfaces) and, in some instances, volatile and/or non-volatile memory (e.g., RAM).

Although the system shown in FIG. 4 illustrates one specific architecture for a computing device 10 for implementing one or more of the embodiments described herein, it is by no means the only device architecture on which at least a portion of the features and techniques described herein may be implemented. For example, architectures having one or any number of processors 13 may be used, and such processors 13 may be present in a single device or distributed among any number of devices. In one aspect, single processor 13 handles communications as well as routing computations, while in other embodiments a separate dedicated communications processor may be provided. In various embodiments, different types of features or functionalities may be implemented in a system according to the aspect that includes a client device (such as a tablet device or smartphone running client software) and server systems (such as a server system described in more detail below).

Regardless of network device configuration, the system of an aspect may employ one or more memories or memory modules (such as, for example, remote memory block 16 and local memory 11) configured to store data, program instructions for the general-purpose network operations, or other information relating to the functionality of the embodiments described herein (or any combinations of the above). Program instructions may control execution of or comprise an operating system and/or one or more applications, for example. Memory 16 or memories 11, 16 may also be configured to store data structures, configuration data, encryption data, historical system operations information, or any other specific or generic non-program information described herein.

Because such information and program instructions may be employed to implement one or more systems or methods described herein, at least some network device embodiments may include nontransitory machine-readable storage media, which, for example, may be configured or designed to store program instructions, state information, and the like for performing various operations described herein. Examples of such nontransitory machine-readable storage media include, but are not limited to, magnetic media such as hard disks, floppy disks, and magnetic tape; optical media such as CD-ROM disks; magneto-optical media such as optical disks, and hardware devices that are specially configured to store and perform program instructions, such as read-only memory devices (ROM), flash memory (as is common in mobile devices and integrated systems), solid state drives (SSD) and “hybrid SSD” storage drives that may combine physical components of solid state and hard disk drives in a single hardware device (as are becoming increasingly common in the art with regard to personal computers), memristor memory, random access memory (RAM), and the like. It should be appreciated that such storage means may be integral and non-removable (such as RAM hardware modules that may be soldered onto a motherboard or otherwise integrated into an electronic device), or they may be removable such as swappable flash memory modules (such as “thumb drives” or other removable media designed for rapidly exchanging physical storage devices), “hot-swappable” hard disk drives or solid state drives, removable optical storage discs, or other such removable media, and that such integral and removable storage media may be utilized interchangeably. Examples of program instructions include both object code, such as may be produced by a compiler, machine code, such as may be produced by an assembler or a linker, byte code, such as may be generated by for example a JAVA™ compiler and may be executed using a Java virtual machine or equivalent, or files containing higher level code that may be executed by the computer using an interpreter (for example, scripts written in Python, Perl, Ruby, Groovy, or any other scripting language).

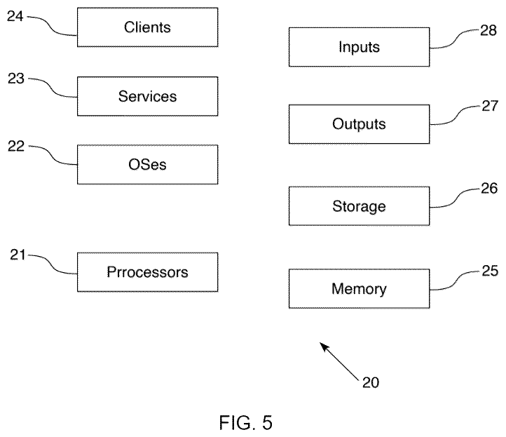

In some embodiments, systems may be implemented on a standalone computing system. Referring now to FIG. 5, there is shown a block diagram depicting a typical exemplary architecture of one or more embodiments or components thereof on a standalone computing system. Computing device 20 includes processors 21 that may run software that carry out one or more functions or applications of embodiments, such as for example a client application. Processors 21 may carry out computing instructions under control of an operating system 22 such as, for example, a version of MICROSOFT WINDOWS™ operating system, APPLE macOS™ or iOS™ operating systems, some variety of the Linux operating system, ANDROID™ operating system, or the like. In many cases, one or more shared services 23 may be operable in system 20 and may be useful for providing common services to client applications. Services 23 may for example be WINDOWS™ services, user-space common services in a Linux environment, or any other type of common service architecture used with operating system 21. Input devices 28 may be of any type suitable for receiving user input, including for example a keyboard, touchscreen, microphone (for example, for voice input), mouse, touchpad, trackball, or any combination thereof. Output devices 27 may be of any type suitable for providing output to one or more users, whether remote or local to system 20, and may include for example one or more screens for visual output, speakers, printers, or any combination thereof. Memory 25 may be random-access memory having any structure and architecture known in the art, for use by processors 21, for example to run software. Storage devices 26 may be any magnetic, optical, mechanical, memristor, or electrical storage device for storage of data in digital form (such as those described above, referring to FIG. 4). Examples of storage devices 26 include flash memory, magnetic hard drive, CD-ROM, and/or the like.

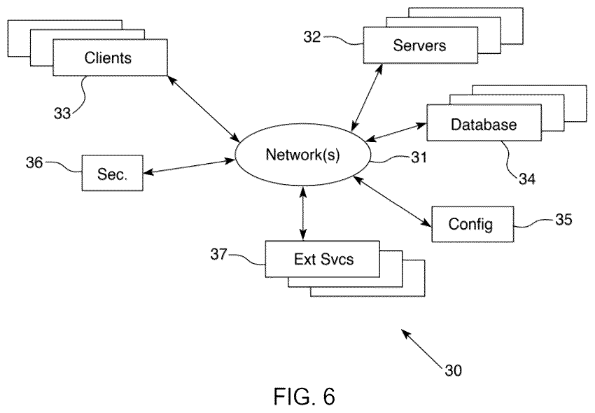

In some embodiments, systems may be implemented on a distributed computing network, such as one having any number of clients and/or servers. Referring now to FIG. 6, there is shown a block diagram depicting an exemplary architecture 30 for implementing at least a portion of a system according to one aspect on a distributed computing network. According to the aspect, any number of clients 33 may be provided. Each client 33 may run software for implementing client-side portions of a system; clients may comprise a system 20 such as that illustrated in FIG. 5. In addition, any number of servers 32 may be provided for handling requests received from one or more clients 33. Clients 33 and servers 32 may communicate with one another via one or more electronic networks 31, which may be in various embodiments any of the Internet, a wide area network, a mobile telephony network (such as CDMA or GSM cellular networks), a wireless network (such as WiFi, WiMAX, LTE, and so forth), or a local area network (or indeed any network topology known in the art; the aspect does not prefer any one network topology over any other). Networks 31 may be implemented using any known network protocols, including for example wired and/or wireless protocols.

In addition, in some embodiments, servers 32 may call external services 37 when needed to obtain additional information, or to refer to additional data concerning a particular call. Communications with external services 37 may take place, for example, via one or more networks 31. In various embodiments, external services 37 may comprise web-enabled services or functionality related to or installed on the hardware device itself. For example, in one aspect where client applications are implemented on a smartphone or other electronic device, client applications may obtain information stored in a server system 32 in the cloud or on an external service 37 deployed on one or more of a particular enterprise's or user's premises.

In some embodiments, clients 33 or servers 32 (or both) may make use of one or more specialized services or appliances that may be deployed locally or remotely across one or more networks 31. For example, one or more databases 34 may be used or referred to by one or more embodiments. It should be understood by one having ordinary skill in the art that databases 34 may be arranged in a wide variety of architectures and using a wide variety of data access and manipulation means. For example, in various embodiments one or more databases 34 may comprise a relational database system using a structured query language (SQL), while others may comprise an alternative data storage technology such as those referred to in the art as “NoSQL” (for example, HADOOP CASSANDRA™, GOOGLE BIGTABLE™, and so forth). In some embodiments, variant database architectures such as column-oriented databases, in-memory databases, clustered databases, distributed databases, or even flat file data repositories may be used according to the aspect. It will be appreciated by one having ordinary skill in the art that any combination of known or future database technologies may be used as appropriate, unless a specific database technology or a specific arrangement of components is specified for a particular aspect described herein. Moreover, it should be appreciated that the term “database” as used herein may refer to a physical database machine, a cluster of machines acting as a single database system, or a logical database within an overall database management system. Unless a specific meaning is specified for a given use of the term “database”, it should be construed to mean any of these senses of the word, all of which are understood as a plain meaning of the term “database” by those having ordinary skill in the art.

Similarly, some embodiments may make use of one or more security systems 36 and configuration systems 35. Security and configuration management are common information technology (IT) and web functions, and some amount of each are generally associated with any IT or web systems. It should be understood by one having ordinary skill in the art that any configuration or security subsystems known in the art now or in the future may be used in conjunction with embodiments without limitation, unless a specific security 36 or configuration system 35 or approach is specifically required by the description of any specific aspect.

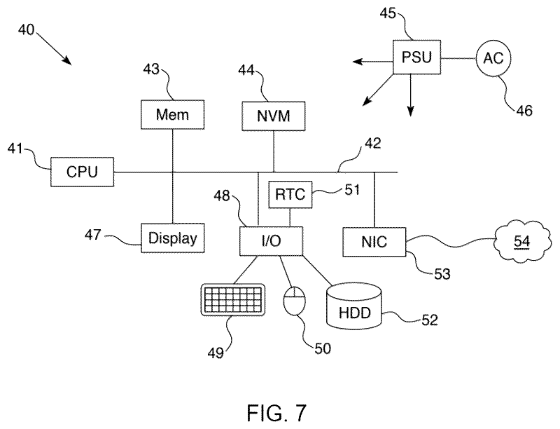

FIG. 7 shows an exemplary overview of a computer system 40 as may be used in any of the various locations throughout the system. It is exemplary of any computer that may execute code to process data. Various modifications and changes may be made to computer system 40 without departing from the broader scope of the system and method disclosed herein. Central processor unit (CPU) 41 is connected to bus 42, to which bus is also connected memory 43, nonvolatile memory 44, display 47, input/output (I/O) unit 48, and network interface card (NIC) 53. I/O unit 48 may, typically, be connected to keyboard 49, pointing device 50, hard disk 52, and real-time clock 51. NIC 53 connects to network 54, which may be the Internet or a local network, which local network may or may not have connections to the Internet. Also shown as part of system 40 is power supply unit 45 connected, in this example, to a main alternating current (AC) supply 46. Not shown are batteries that could be present, and many other devices and modifications that are well known but are not applicable to the specific novel functions of the current system and method disclosed herein. It should be appreciated that some or all components illustrated may be combined, such as in various integrated applications, for example Qualcomm or Samsung system-on-a-chip (SOC) devices, or whenever it may be appropriate to combine multiple capabilities or functions into a single hardware device (for instance, in mobile devices such as smartphones, video game consoles, in-vehicle computer systems such as navigation or multimedia systems in automobiles, or other integrated hardware devices).

In various embodiments, functionality for implementing systems or methods of various embodiments may be distributed among any number of client and/or server components. For example, various software modules may be implemented for performing various functions in connection with the system of any particular aspect, and such modules may be variously implemented to run on server and/or client components.

The skilled person will be aware of a range of possible modifications of the various embodiments described above. Accordingly, the present invention is defined by the claims and their equivalents.

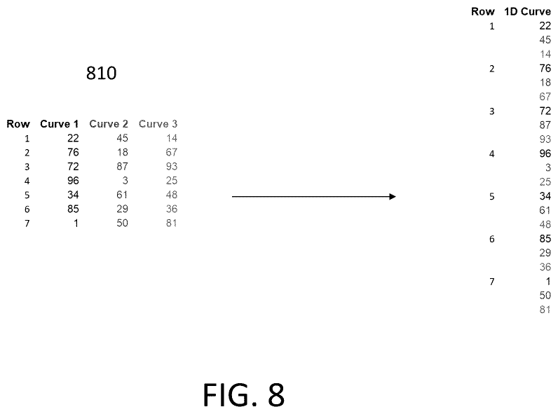

FIG. 8 includes three sample curves 810 (e.g., well log category values arranged according to the depth at which they are observed) in a tabular format. Each column can represent a different category of measurement of the well log.

In some implementations, the system can pre-process the well log data by reducing its dimensionality to a single dimension. For example, rows can be combined into one column by interleaving values from each curve sequentially (e.g., as shown in 820). Although this method transforms the data into a single curve, can preserve all original data points.

But the reduced sampling rate of this series (e.g., at 64 Hz) can be insufficient for processing using conventional Fast Fourier Transform (FFT) algorithms. Therefore, the system can upsample the dataset (e.g., to 8000 Hz). Subsequently, the data series can be converted into a standard audio format such as Motion Picture Experts Group Audio Layer III (mp3) or waveform audio format (WAV).

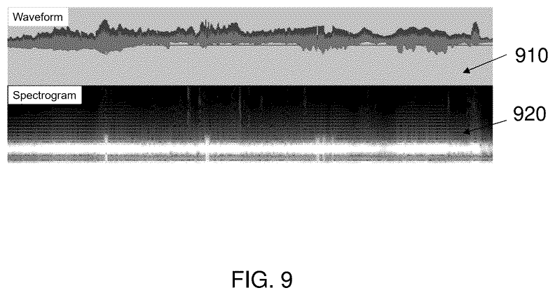

FIG. 9 illustrates an audio waveform (910) from a Denver-Julesburg (DJ) well above the resulting spectrogram (920), which can be used for hash matching. In creating fingerprints, the spectrogram can be input into a system that detects spectral peaks and identifies vectors connecting the spectral peaks to one another.

Once the well log data is converted into audio format, the system can extract digital tokens (e.g., hashes), which can serve as marker fingerprints. These digital tokens can be then stored in a database for all wells under analysis.

Then, the system can extract data from a window surrounding a specific marker. This can be a user-defined marker or pre-defined from a third party.

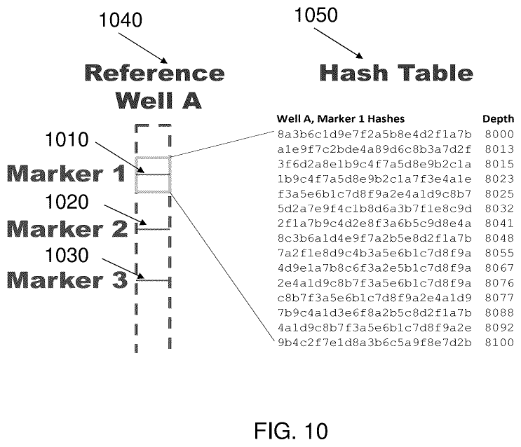

FIG. 10 illustrates a search for Marker 1 (1010) using a window of 100 feet, with a range of plus or minus 50 feet from the reference marker.

The system can generate a list of tokens (e.g., hashes), which can be unique identifiers or fingerprints for different features in the well log data. The system can then match these tokens across different wells, allowing the system to identify corresponding markers between or among a group of wells. To facilitate this, the well log depths can be converted to time units to operate in an audio context rather than a depth-based one. After the time-based offsets between the reference well and the target well are calculated, and the offset information can be converted back from time units to depth units.

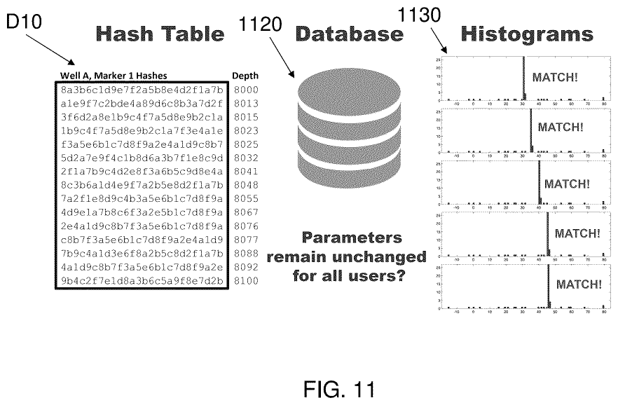

FIG. 11 illustrates a process of searching for a presence or an absence of a geological feature match (e.g., marker), in accordance with some implementations. Target wells located within a depth range from the reference well can be scanned for the digital tokens. Note that well databases will be significantly smaller than those required for music recognition.

Matches can be identified in those wells if a pattern of digital tokens in the target well (shown in table 1110) sufficiently resembles the marker of the reference well, which may have its tokens stored in database 1120. This matching process can be performed across to compare many different wells. Visualizations, such as histograms 1130, can illustrate marker matches in relation to their depth placements in the compared wells.

While music recognition attempts to match a song recording captured in the presence of noise and distortion to a reference recording in a database, the system can analyze for wells that differ in geology, log vintage, noise and many other factors that can complicate a search for matching features in wells. The system can perform well matching despite these complications, similar to how music recognition can match a song to a reference even when the captured song recording has distortion or noise that degrade or modify the signal,

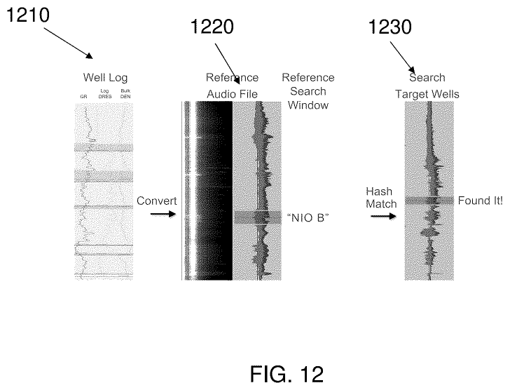

FIG. 12 illustrates a matching process using well logs containing measurements from three categories: gamma radiation, resistivity, and bulk density.

The reference well log (e.g., 1210) and target well logs can be first transformed into audio files (e.g., reference audio file 1220 and target audio file 1230). This conversion process can preserve all curve information while transitioning from the depth domain to the time domain, allowing for audio techniques to be applied. Sets of digital tokens of these audio files can then be generated and cataloged in a database for subsequent retrieval.

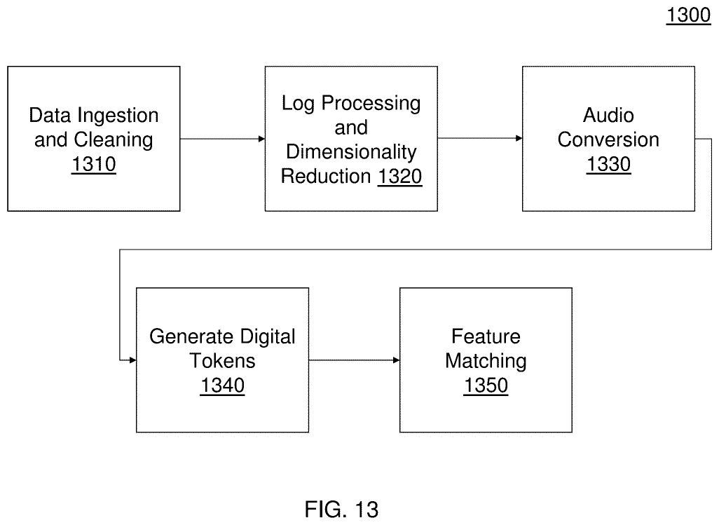

FIG. 13 illustrates a process for performing well matching, in accordance with some implementations. In some cases, the operations described herein may be applicable in contexts beyond geological feature comparison. For example, a combination of the pre-processing, audio (or other representation) conversion, digital token (e.g., hash) generation, and marker searching can be applied to, for example, seismic data, biological data (e.g., DNA sequencing), and financial time-series analysis, using data from datasets such as biological datasets or financial datasets.

### Data Ingestion and Cleaning

Data ingestion and cleaning 1310 can ensure the extracted well log data is clean, consistent, and ready for processing. This step can maintain the reliability and accuracy of the downstream processes.

### Data Standardization

Depth measurements from different sources are often inconsistent. The system rounds depth measurements to the nearest half-foot interval to ensure uniformity across logs.

### Null Value Handling

Logs of well resistivity data may contain zeros, which are physically implausible and can indicate of sensor errors. The system can replace zero values with a small nonzero values (e.g., 0.5), preserving continuity and enabling effective pattern recognition.

### Depth Filtering

The system can filter out surface noise and irrelevant sections by focusing on geologically significant depth ranges. This can reduce computational overhead by processing only relevant sections.

### 2. Log Processing and Dimensionality Reduction

In operation 1320, the system can transform three-dimensional (3D) well log data (depth and one or more category measurements, such as resistivity or gamma radiation) into a one-dimensional (1D) signal for downstream audio processing.

### Log Combination Strategy

Each log (Gamma Ray, Resistivity, Bulk Density) can be normalized independently to preserve relative variations. And instead of concatenating logs, the system can interleave them to retain the spatial relationships of measurements at the same depth. This approach can increase robustness against individual sensor errors.

### Window-Based Processing

Window-based processing can divide logs into overlapping windows to maintain context at window boundaries and minimize edge effects during Fast Fourier Transform (FFT) processing. Window-based processing can also enable pattern recognition across transitions and enhances matching accuracy.

In some cases, the system can perform additional or alternative pre-processing techniques, such as processing well log data into signal pattern representations or generating representations based on summary statistics (e.g., mean, median, mode, or variance).

### 3. Audio Conversion

In operation 1330, the cleaned and processed log data can be converted into an audio format, enabling the use of optimized signal processing techniques.

### Signal Processing Advantages

Audio libraries can be well-suited for noise handling and computationally efficient pattern matching. Audio fingerprinting algorithms can be effective for identifying patterns under variable conditions.

### Depth-Time Mapping

Depth-time mapping can map depth information into time to preserve spatial relationships within the logs. Depth-time mapping can ensure reverse mapping of matches back to depth for accurate geological interpretation. Depth-time mapping can maintain consistent sampling rates across logs to avoid distortions.

In some cases, the system may convert the well log data into a non-audio format.

Examples of non-audio formats may comprise, but are not limited to frequency domain representations, signal patterns, or statistical summaries, which allow for adaptable processing frameworks. In some cases, the system can use domain-specific filters or transformations to extract features. For example, the system can perform geological signal processing technique to produce depth-to attribute transformations for feature recognition. The system can also generate encodings of inter-well relationships as adjacency matrices.

### Multimodal Transformation

Data can be transformed into one or more representations (e.g., signal-based, statistical, or graphical) that support a variety of analytical methods such as cross-correlation, feature extraction, or clustering.

### Signal Encoding for Efficient Matching

Serial well log data can be converted into a format that encodes spatial patterns in a structured and compressible manner. The output format can support pattern analysis techniques like frequency domain transformations, feature extraction, and hashing.

Or more generally:
Symbolic Data Transformation: Converting continuous data into symbolic representations (e.g., feature vectors or hashes).
Multiform Signal Mapping: Indicating that the transformation outputs multiple signal forms (e.g., time-series, spectra) for analysis flexibility.

### 4. Tokenizing Process

In operation 1340, the system transforms transformed signals (e.g., audio signals) into digital tokens (e.g., unique hashes) for fast and reliable pattern matching.

### Spectrogram Generation

Operation 1340 can generate a spectrogram from the one or more transformed signals (e.g., audio signals). The system can utilize Short-Time Fourier Transform (STFT) with overlapping windows to capture localized patterns. Frequency masking can emphasize geologically relevant frequencies. Log-transformed amplitudes can enhance the representation of geological variations.

### Token Generation

Token generation can create constellation maps based on spectral peaks. The tokens can comprise hashes. Hashes can use relative time offsets to ensure they are:
Rotation Invariant: Robust to shifts in the frequency domain.
Noise Resistant: Handles signal distortions effectively.
Scale Independent: Preserves patterns across varying amplitudes.

### 5. Perform Matching

In operation 1350, the system can perform geological feature matching to match well log formations by incorporating geological constraints to ensure accuracy and stratigraphic validity.
Hierarchical Matching
Identifies the most confident pick first and uses it as an anchor.
Applies geological rules to enforce stratigraphic order during subsequent matches.
Confidence Metrics
Window Distinctiveness: Assesses uniqueness of patterns within the search window.
General Distinctiveness: Evaluates overall uniqueness across the entire log.
Average Window Distinctiveness: Provides a stability metric for matches.

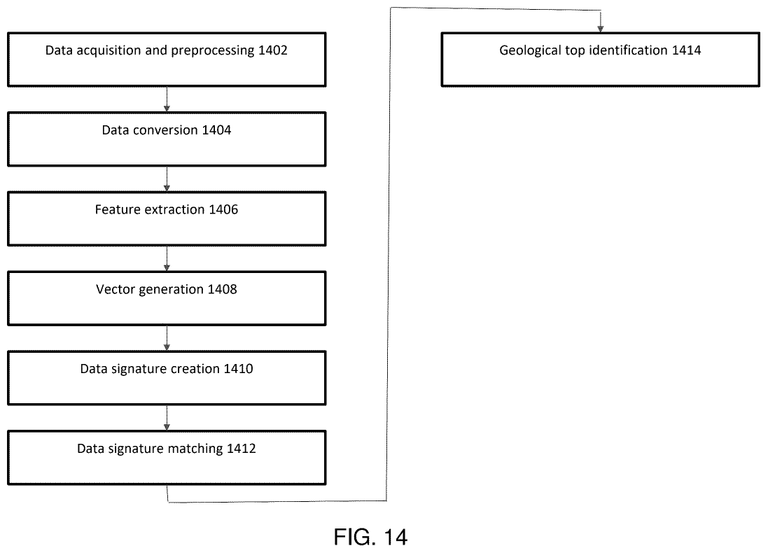

FIG. 14 illustrates, in accordance with an embodiment of the invention, a Geological tops Identification Process for executing the inventive concepts described herein. In one embodiment, the process is comprised of the following steps: Data acquisition and preprocessing 1402, Data conversion 1404, Feature extraction 1406, Vector generation 1408, Data signature creation 1410, Data signature matching 1412, and Geological top identification 1414. This process employs serial or sequential data and markers, such as geologic tops, from Reference entities (e.g., Reference wells), to identify corresponding marker locations in Target entities (e.g., Target wells).

Data acquisition and preprocessing 1402, may involve obtaining well log data from various sources and preparing it for further analysis. Data acquisition and preprocessing 1402 may comprise gathering well log data from different sources, such as databases, files, or real-time data streams. The data may include various types of well logs and/or geological sensors associated with a location, such as gamma ray, resistivity, and bulk density logs, and may be in different formats, such as LAS (Log ASCII Standard), DLIS (Digital Log Interchange Standard), or proprietary formats.

Once the data is acquired, it undergoes a series of preprocessing steps to ensure its quality and consistency. Data acquisition and preprocessing 1402 may standardize the depth measurements to the nearest half-foot interval, ensuring that all the well logs have a consistent depth reference, making it easier to compare and analyze them. Next, the preprocessing step handles null values in the well log data. Null values, such as zeros in resistivity logs, are physically implausible and may indicate sensor errors. To maintain data integrity, these null values are replaced with small nonzero values, preserving the continuity of the data and enabling effective pattern recognition in later stages. The preprocessing step may also involve filtering out surface noise and irrelevant sections of the well logs. By focusing on geologically significant depth ranges, the system can reduce computational overhead and improve the efficiency of the analysis. This filtering process may involve removing data points above or below certain depth thresholds or applying domain-specific filters to remove noise.

After the data is cleaned and filtered, data acquisition and preprocessing 1402 transforms the three-dimensional (3D) well log data into a one-dimensional (1D) signal. This transformation is necessary to prepare the data for downstream audio processing or other signal processing techniques. The transformation process involves normalizing each log (gamma ray, resistivity, bulk density) independently to preserve their relative variations. The normalized logs are then interleaved to retain the spatial relationships of measurements at the same depth, creating a single ID signal that represents the well log data. For example, if three log curves (Curve A, Curve B, Curve C) are recorded at regular intervals, interleaving these curves results in a 1D series (Series D) that is three times the original length.

To further enhance the signal processing capabilities, the preprocessing step may divide the 1D signal into overlapping windows. This window-based processing approach helps maintain context at window boundaries and minimizes edge effects during techniques like Fast Fourier Transform (FFT) processing. It also enables pattern recognition across transitions and enhances matching accuracy in later stages. Data acquisition and preprocessing 1402 may also comprise upsampling the standardized data, similar to steps found in FIG. 3. This data may replace the standardized dataset or generate a new data set saved to the database.

Alternative approaches to data acquisition and preprocessing may include handling missing data by using interpolation techniques to estimate missing data points based on neighboring values, outlier detection algorithms to identify and remove anomalous data points that may affect the analysis, data resampling to ensure consistency across different logs with varying sampling rates, domain-specific preprocessing techniques such as log normalization based on geological formations or applying specific filters to enhance certain features of interest, and data compression techniques to reduce storage requirements and improve processing efficiency. Parameters and constraints may also be applied to the data acquisition 1402 and data conversion steps in a similar fashion to steps found in FIG. 3.

Data conversion 1404, may transform the cleaned and processed well log data into a format suitable for efficient pattern matching and analysis. A purpose of data conversion is to convert the well log data into a representation that facilitates the application of signal processing techniques and enables effective pattern recognition.

Data conversion 1404 may transform the well log data into an audio format. This transformation allows the use of well-established audio processing libraries and algorithms for noise handling and computationally efficient pattern matching. Audio fingerprinting algorithms, which are designed to identify patterns in audio signals under variable conditions, can be particularly effective for matching well log patterns across different wells. The system maps the depth information into time, preserving the spatial relationships within the logs. This depth-time mapping ensures that the relative positions of the well log measurements are maintained in the audio representation. The conversion process also involves ensuring consistent sampling rates across different logs to avoid distortions and maintain comparability.

In addition to audio format conversion, Data conversion 1404 may employ alternative data conversion techniques depending on the specific requirements of the analysis or the nature of the well log data. These alternative approaches include frequency domain representation, where the well log data can be converted into a frequency domain representation using techniques such as Fourier transforms or wavelet transforms, highlighting the frequency components present in the data and revealing patterns and features that may not be apparent in the time domain. These alternative approaches include frequency domain representation, where the well log data can be converted into a frequency domain representation using techniques such as Fourier transforms or wavelet transforms. While Fourier transforms provide a global analysis of frequency components, wavelet transforms decompose the data into multiple scales, allowing both frequency and spatial localization. This multi-scale approach highlights fine-grained, high-frequency features at smaller scales and broader, low-frequency trends at larger scales, revealing patterns and features that may not be apparent in the time domain; signal pattern representation, where the system can convert the well log data into a representation that emphasizes specific signal patterns or characteristics, involving the application of domain-specific filters or transformations to extract relevant features, such as amplitude variations, slope changes, or cyclical patterns, tailored to capture geologically significant patterns and enhance the discriminative power of the subsequent analysis steps; statistical summarization, where the well log data can be converted into a statistical representation that captures key statistical properties of the data, including calculating summary statistics such as mean, median, mode, variance, or higher-order moments for specific depth intervals or windows, providing a compact and informative summary of the well log data for pattern matching and comparison across different wells; and graphical representation, where the system can convert the well log data into a graphical representation, such as a heatmap or a two-dimensional matrix, encoding the relationships between different well logs or capturing the spatial dependencies within the data, particularly useful for visualizing patterns and identifying similarities or differences between wells. Step 1404 may employ multiple data conversion techniques in parallel or in a hierarchical manner to capture different aspects of the data and enhance the robustness of the pattern matching process.

Feature extraction 1406, may generate spectrograms from the transformed well log signals, such as audio signals, to capture and highlight geologically relevant patterns and features. Step 1406 may extract meaningful information from the converted well log data that can be used for effective pattern matching and analysis in subsequent stages. The feature extraction process may begin by utilizing the Short-Time Fourier Transform (STFT) to generate spectrograms from the transformed signals. STFT is a widely used technique in signal processing that allows for the analysis of time-varying frequency content in a signal. By applying STFT to the transformed well log signals, the system can obtain a time-frequency representation of the data, where the spectrogram represents the frequency content of the signal over time. To generate the spectrograms, the method employs overlapping windows in the STFT process. These overlapping windows capture localized patterns and features in the well log data. By sliding the window along the time axis and computing the Fourier transform for each window, the system can identify and extract patterns that may be specific to certain geological formations or features.

In addition to the STFT, Feature extraction 1406 may apply frequency masking to emphasize geologically relevant frequencies in the spectrograms. Frequency masking involves selectively amplifying or attenuating specific frequency ranges based on their geological significance. By emphasizing frequencies that are known to be associated with particular geological features, such as specific rock types or fluid content, the system can enhance the discriminative power of the spectrograms and improve the accuracy of pattern matching. Step 1406 may also comprise the use of log-transformed amplitudes in the spectrograms. By applying log transformation to the amplitudes of the spectrograms, the system can enhance the representation of geological variations and make them more prominent for pattern recognition.

The resulting spectrograms, with emphasized geologically relevant frequencies and log-transformed amplitudes, serve as a rich set of features that can be used for pattern matching and analysis in the subsequent stages of the process. These features capture the essential characteristics of the well log data and provide a compact representation that facilitates efficient comparison and correlation between different wells.

Alternative approaches to Feature extraction 1406 may include wavelet transforms, where the system can employ wavelet transforms to generate time-frequency scalogram representations of the well log data, providing a multi-resolution analysis of the signal and allowing for the capture of both time and frequency localized features at different scales, particularly useful for identifying patterns and features that occur at different resolutions in the well log data; adaptive frequency masking, where the system can employ adaptive frequency masking techniques that automatically identify and emphasize geologically relevant frequencies based on the characteristics of the well log data, involving the use of machine learning algorithms to learn the optimal frequency ranges for a given geological setting or using domain knowledge to define adaptive frequency masks that adapt to the specific features of interest; feature selection techniques, where in addition to generating spectrograms, the system can apply feature selection techniques to identify the most informative and discriminative features from the well log data, involving the use of statistical methods, such as principal component analysis (PCA) or independent component analysis (ICA), to extract a reduced set of features that capture the essential variability in the data, helping to reduce the dimensionality of the feature space and improve the efficiency of pattern matching; and domain-specific features, where the feature extraction process can incorporate domain-specific features that are tailored to the specific geological context or the characteristics of the well log data, such as extracting features related to the shape, amplitude, or frequency content of specific geological markers or using domain knowledge to define custom features that are indicative of particular geological formations or fluid types.

Feature extraction 1406 may further identify unique features which may comprise, but are not limited to localized peaks, valleys, or extrema in the matrix values that represent transitions or anomalies, spectral peaks derived from one of a plurality of mathematical transformations. The mathematical transformations may include, but are not limited to, Short-Time Fourier Transform (STFT), Continuous Wavelet Transform (CWT), Wavelet Packet Transform (WPT), or Gabor Transform, and statistical measures including zero-crossing rates, signal energy, or entropy to highlight regions of interest.

Vector generation 1408, may create a compact and robust representation of the extracted features from the well log data. Step 1408 aims to transform the spectrograms generated in Feature extraction 1406 into a set of vectors that capture the essential characteristics of the data while ensuring rotation invariance, noise resistance, and scale independence. Vector generation 1408 may correspond directly to Create Marker Fingerprints 310 in FIG. 3. Both steps involve generating representations essential for downstream matching and identification processes.

Vector generation 1408 may create constellation maps based on the spectral peaks present in the spectrograms. Spectral peaks represent the dominant frequencies or energy concentrations in the well log data and can be indicative of specific geological features or patterns. By identifying and extracting these spectral peaks, the system can generate a constellation map that provides a concise representation of the key features in the data. The constellation map can be constructed by considering the relative positions and magnitudes of the spectral peaks, creating a unique fingerprint for each well log.

Step 1408 may employ relative time offsets. Instead of using absolute time or depth values, the vectors are constructed based on the relative positions of the spectral peaks. This approach ensures that the resulting vectors are rotation invariant, meaning that they remain consistent even if the well log data undergoes rotational transformations. Rotation invariance is crucial for accurate pattern matching, as it allows the system to identify similar geological features regardless of their orientation or position within the well log. Furthermore, the vector generation process incorporates techniques to enhance noise resistance and scale independence. Noise resistance is achieved by applying appropriate thresholds and filtering techniques to the spectral peaks. By considering only the most prominent and stable peaks, the method may mitigate the impact of noise and artifacts in the well log data. Scale independence may be another important aspect of vector generation. The system normalizes the vectors based on the overall magnitude or energy of the spectral peaks. By scaling the vectors appropriately, the system ensures that the relative proportions and relationships between the peaks are preserved, regardless of the absolute scale of the well log data. Vectors may also have a set of parameters applied to them to further assist with narrowing or filtering important information. The parameters may comprise but are not limited to frequency, time offset, and amplitude differences.

The resulting vectors, generated using relative time offsets and incorporating noise resistance and scale independence, provide a compact and discriminative representation of the well log data. These vectors may be efficiently compared and matched against a database of reference vectors to identify similar geological features or patterns across different wells. The vector representation enables fast and accurate pattern matching, as it reduces the dimensionality of the data while preserving the essential characteristics.

Alternative approaches to vector generation may include wavelet-based vector generation, where instead of using spectral peaks, the system can generate vectors based on wavelet coefficients, providing a multi-resolution analysis of the well log data and allowing for the capture of both time and frequency localized features, creating a compact and informative representation of the data; feature-based vector generation, where the system can generate vectors based on a combination of different features extracted from the well log data, incorporating other relevant features such as statistical measures (e.g., mean, variance), morphological characteristics (e.g., shape, texture), or domain-specific attributes (e.g., fluid content, porosity), providing a more comprehensive representation of the well log data; learning-based vector generation, where machine learning techniques can be employed to learn the optimal vector representation from the well log data, by training a neural network or other learning models on a large dataset of well logs, automatically discovering the most discriminative and informative features for vector generation, adapting to the specific characteristics of the data and improving the accuracy of pattern matching; and sparse coding-based vector generation, where sparse coding techniques can be used to generate vectors that represent the well log data as a linear combination of a set of basis vectors, by learning a dictionary of basis vectors that capture the essential patterns and features in the data, generating sparse and compact vectors that efficiently encode the well log information, helping in reducing the dimensionality of the data while preserving the key characteristics.

Data signature creation 1410, involves transforming the vectors generated in the previous step (vector generation, step 1408) into a compact and efficient representation known as digital tokens or unique hashes. The primary purpose of this step is to enable fast and reliable pattern matching by converting the vectors into a format that facilitates efficient retrieval and comparison. Data signatures may be equivalent to FIG. 3's marker fingerprints.

Data signature creation 1410 may take the vectors generated from the well log data and apply a hashing algorithm to them. The hashing algorithm takes the input vector and generates a unique hash that serves as a fingerprint or signature of the original data. Even small changes in the input vector result in a significantly different hash, making it highly sensitive to variations in the data. Data signature creation 1410 hashing algorithms may comprise at least one of Locality Sensitive Hashing (LSH), Secure Hash Algorithm 1 (SHA-1), Secure Hash Algorithm 256 (SHA-256), Secure Hash Algorithm 512 (SHA-512), Message-Digest Algorithm 5 (MD5), MurmurHash, FNV (Fowler-Noll-Vo) Hash, CityHash, FarmHash, XXHash, Tabulation Hashing, Polynomial Hashing, SimHash, MinHash, Concatenation Hashing, Hash Modulo, and CRC32 (Cyclic Redundancy Check 32-bit). The selection of the hashing algorithm depends on the specific requirements of the application, such as the desired level of uniqueness, the size of the hash, and the computational resources available. The selection of the hashing algorithm may be determined by user input or directed by an algorithm.

Once the digital tokens are generated, they may be stored in a database for efficient retrieval and comparison. The database acts as a central repository for the digital tokens, allowing for fast lookup and matching operations. The database may be organized using various indexing techniques, such as hash tables or tree-based structures, to optimize the search and retrieval process. The choice of database technology depends on factors such as the scale of the data, the required query performance, and the available storage resources. The stored digital tokens serve as a compact and efficient representation of the well log data. Instead of comparing the raw well log measurements or the entire vectors, the system can quickly compare the digital tokens to identify similar patterns or matches. The use of digital tokens significantly reduces the computational overhead and speeds up the pattern matching process. By comparing the digital tokens, the system can efficiently search for similar geological features across a large number of wells, enabling rapid and accurate analysis of the well log data.

Alternative approaches to data signature creation may include Locality-Sensitive Hashing (LSH), which is a technique that generates hash values such that similar vectors are more likely to have similar hash values, particularly useful for high-dimensional data and can help in finding approximate nearest neighbors efficiently, enabling faster and more accurate similarity search by creating digital tokens that preserve the locality properties of the vectors; Bloom Filters, which are probabilistic data structures that can be used for efficient membership testing, representing a set of digital tokens using a binary array and multiple hash functions, providing a space-efficient way to check whether a digital token exists in the database, allowing for fast and approximate pattern matching; Perceptual Hashing, which generates digital tokens that are robust to minor variations in the input data, aiming to create hash values that are similar for perceptually similar vectors, even if they have slight differences, useful in scenarios where the well log data may have small variations or noise but still represent the same geological features; and Learned Hashing, where machine learning techniques can be employed to learn hash functions that are optimized for the specific characteristics of the well log data, by training a neural network or other learning models on a large dataset of well log vectors, learning to generate digital tokens that capture the most discriminative and informative features of the data, adapting to the specific patterns and structures present in the well log data, potentially improving the accuracy and efficiency of pattern matching.

Data signature matching 1412, comprises geological feature matching to identify and correlate similar well log formations across different wells. Step 1412 may accurately match geological features by comparing the digital tokens or signatures generated in the previous step (data signature creation, step 1410) while incorporating geological constraints to ensure the validity and consistency of the matches.

The data signature matching process begins by retrieving the digital tokens from the database and comparing them across different wells. The comparison is performed using at least one of similarity measures and distance metrics that quantify the similarity between the digital tokens. Similarity measures may comprise, but are not limited to Euclidean distance, cosine similarity, and Jaccard similarity. The choice of similarity measure depends on the nature of the data and the desired properties of the matching process, such as sensitivity to magnitude differences or emphasis on pattern similarity.

The method may incorporate geological constraints into the matching process. These constraints are based on domain knowledge and geological rules that govern the stratigraphic relationships between different formations. One key constraint is to identify the most confident pick first and use it as an anchor for subsequent matches. The most confident pick refers to a geological feature or formation that has a highly distinctive and unique signature, making it easier to identify and match across different wells. By starting with the most confident pick, the system establishes a reliable reference point for aligning and correlating other formations. Once the anchor pick is identified, the system applies geological rules to enforce stratigraphic order during subsequent matches. Stratigraphic order refers to the relative positioning and sequence of geological formations based on their age and depositional history. The system ensures that the matched formations adhere to the expected stratigraphic order, preventing geologically implausible or inconsistent matches. For example, if formation A is known to be older than formation B, the system will not allow a match where formation B appears above formation A in a well log.

To assess the quality and reliability of the matches, the system calculates various confidence metrics. These metrics provide quantitative measures of the distinctiveness and stability of the matched patterns. One metric is window distinctiveness, which evaluates the uniqueness of the patterns within a specific search window. The search window refers to a defined interval or range of well log data around the target formation. By assessing the distinctiveness of the patterns within the search window, the system can determine the likelihood of a true match and reduce the chances of false positives. Another confidence metric is general distinctiveness, which assesses the overall uniqueness of the matched pattern across the entire well log. This metric considers the similarity of the matched pattern to other patterns present in the well log, providing an indication of its global uniqueness. A high general distinctiveness score suggests that the matched pattern is highly specific and unlikely to be confused with other formations. The system also computes the average window distinctiveness, which serves as a stability metric for the matches. The average window distinctiveness is calculated by considering the distinctiveness scores of multiple search windows around the target formation. A high average window distinctiveness indicates that the matched pattern is consistently distinct across different intervals, providing confidence in the stability and reliability of the match. Confidence metrics may comprise, but are not limited to fingerprint density, match percentage, average match offset, target fingerprint percentage from the stored fingerprint data.

Weighted averages may also be calculated by taking the location of the pick for each method derived from a plurality of features or factors identified by similarity algorithms. Then weighting each pick by the confidence metric associated with the respective feature or factor; and calculating a weighted average location for the pick based on the weighted contributions of the confidence metrics

Alternative approaches to data signature matching may include Dynamic Time Warping (DTW), which is a technique that allows for non-linear alignment of time series data, used to match well log patterns that may have variations in depth or thickness, computing the optimal alignment between two sequences by minimizing the distance between them, allowing for stretching or compression of the sequences to find the best match; Machine Learning-based Matching, where machine learning algorithms, such as support vector machines (SVM) or deep learning models, can be trained to learn the patterns and characteristics of geological formations from a large dataset of well logs, and then used to classify and match new well log data based on the learned patterns, potentially improving the accuracy and robustness of the matching process; Multi-scale Matching, where multi-scale matching techniques analyze the well log data at different scales or resolutions to capture patterns and features that may be present at various levels of detail, considering matches at multiple scales to identify both large-scale formations and fine-grained variations, providing a more comprehensive and accurate matching result; and Probabilistic Matching, where probabilistic matching approaches assign probability scores to potential matches based on the similarity of the digital tokens and the geological constraints, reflecting the likelihood of a match being correct, allowing for a more nuanced and flexible interpretation of the matching results, particularly useful in scenarios where there is uncertainty or variability in the well log data.

Geological top identification 1414, may identify the geological tops or markers based on the results obtained from the data signature matching process (step 1412). Step 1414 may accurately determine the depths or locations of the geological tops within each well log and to prioritize and validate the identified tops using confidence metrics and visual representations.

Geological top identification 1414 may analyze the matched data signatures and their corresponding depth or location information. The method examines the similarity scores or distance metrics calculated during the data signature matching step to determine the most likely positions of the geological tops. The tops are identified based on the highest similarity scores or the smallest distances between the data signatures of the reference well and the target wells. To prioritize and validate the identified tops, the system utilizes the confidence metrics calculated in the previous step. These metrics, such as window distinctiveness, general distinctiveness, and average window distinctiveness, provide quantitative measures of the reliability and stability of the matched patterns. The system assigns higher priority to the tops with higher confidence metrics, indicating a higher likelihood of accurate identification. The confidence metrics also serve as a validation mechanism, helping to filter out false positives or uncertain matches.

In addition to the confidence metrics, the system employs visual representations to further validate and interpret the identified geological tops. The visualization process involves generating various graphical displays, including log displays, cross-sections, and maps, to present the results in a comprehensive and intuitive manner. The log displays provide a detailed view of the individual well logs, showcasing the identified geological tops along with relevant well log curves and data signatures. The system displays per-well curves, such as gamma ray, resistivity, and density logs, to provide context and support the interpretation of the identified tops. Additionally, the log displays may include match percentage versus depth curves, which indicate the similarity between the reference well and the target wells at different depths. Target fingerprint percentage curves showcase the uniqueness of the matched patterns within each target well, while average match offset curves highlight any consistent shifts or displacements between the reference and target wells.

To enhance the interpretability of the results, the system generates combined curves derived from the Feature Matrix. These combined curves represent a synthesis of multiple well log measurements, providing a comprehensive view of the geological characteristics at each depth. The combined curves can be displayed alongside the individual well log curves to facilitate the identification and correlation of geological features across different wells. The visualization process also includes displaying marker fingerprints, which are the unique data signatures associated with each geological top. These fingerprints serve as visual representations of the key patterns or features that define each top, aiding in the recognition and comparison of tops across different wells. The log curves used to create the combined curves are also visualized, allowing users to understand the contributions of individual measurements to the overall geological characterization.

Furthermore, the system displays the system-picked markers, which are the geological tops automatically identified by the data signature matching process. These markers are visually distinguished from the reference markers, which are the tops manually picked or provided as input to the system. By comparing the system-picked markers with the reference markers, users can assess the accuracy and reliability of the automated top identification process. To facilitate the analysis of geological tops at different scales, the system provides scalable visualizations. Users can examine the identified tops in detail by zooming in to specific well sections or intervals. This allows for a close inspection of the data signatures, confidence metrics, and associated well log curves. Additionally, users can assess the spatial distribution and continuity of the geological tops over broader areas by zooming out to view cross-sections or maps encompassing multiple wells. This scalability enables users to identify regional trends, correlate tops across different wells, and make informed decisions based on a comprehensive understanding of the subsurface geology.

Alternative approaches to geological top identification may include rule-based systems, which utilize predefined rules and criteria to identify geological tops based on the characteristics of well log data, derived from domain knowledge, expert input, or statistical analysis of historical data, applying these rules to the matched data signatures and well log curves to determine the presence and location of geological tops; machine learning models, such as decision trees, random forests, or neural networks, which can be trained on a labeled dataset of well logs and corresponding geological tops, learning the patterns and relationships between the well log data and the tops, enabling them to predict the presence and location of tops in new or unseen well logs, capturing complex and non-linear relationships, potentially improving the accuracy and robustness of top identification; probabilistic approaches, which assign probability distributions to the possible locations of geological tops based on the matched data signatures and confidence metrics, considering the uncertainty and variability inherent in the data and providing a probabilistic assessment of the top locations, using methods such as Bayesian inference or Markov Chain Monte Carlo (MCMC) techniques to estimate the posterior probability distribution of the top locations given the observed data; and interactive visualization and manual refinement, where in addition to the automated identification of geological tops, the system can provide interactive visualization tools that allow users to manually refine or adjust the top locations, interacting with the log displays, cross-sections, and maps to add, remove, or modify the tops based on their expertise and interpretation, combining the efficiency of automated top identification with the flexibility and domain knowledge of human experts.

By identifying the geological tops based on the data signature matching results, utilizing confidence metrics for prioritization and validation, and providing comprehensive visualizations, the geological top identification step (1414) enables accurate and reliable determination of the key geological features within the well logs. The identified tops serve as crucial inputs for subsequent geological analysis, reservoir characterization, and decision-making processes in various domains, such as oil and gas exploration, geothermal energy development, and carbon sequestration.

### System Summary

This process can leverage a combination of modern signal processing techniques, robust geological constraints, and advanced visualization tools to automate well log correlation while maintaining geological validity. The system's structured approach can ensure efficient, accurate, and interpretable results.

### ADDITIONAL CONSIDERATIONS

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

Some embodiments may be described using the expression “coupled” and “connected” along with their derivatives. For example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and Bis false (or not present), A is false (or not present) and Bis true (or present), and both A and B are true (or present).

In addition, use of the “a” or “an” are employed to describe elements and components of the embodiments herein. This is done merely for convenience and to give a general sense of the invention. This description should be read to include one or at least one and the singular also includes the plural unless it is obvious that it is meant otherwise.

Upon reading this disclosure, those of skill in the art will appreciate still additional alternative structural and functional designs for a system and/or a process associated with the disclosed principles herein. Thus, while particular embodiments and applications have been illustrated and described, it is to be understood that the disclosed embodiments are not limited to the precise construction and components disclosed herein. Various apparent modifications, changes and variations may be made in the arrangement, operation and details of the method and apparatus disclosed herein without departing from the spirit and scope defined in the appended claims.

What is claimed is:

1. A computer implemented method for identifying geological tops from well log data, the computer implemented method comprising:
obtaining sensor data from geological sensors, wherein the geological sensors are associated with a plurality of locations;
storing the set of sensor data on a database;
standardizing and conditioning the stored sensor data to generate standardized sensor data set;
replicating data points from the standardized data set and flattening the replicated data points into a one-dimensional linear series by interleaving data elements from each attribute across all replicated data points, wherein the resulting flattened series preserves the relative order and relationships of the original multi-attribute data;
upsampling the flattened data set to generate an intermediate dataset;
replacing the standardized data set with the intermediate dataset;
generating a secondary data set by converting the standardized data set into a secondary data format by using a matrix conversion technique, wherein the secondary dataset comprises an M×N matrix;
identifying unique features in the M×N matrix by detecting data patterns, the unique features comprising at least one of localized peaks, valleys, or extrema in the matrix values that represent transitions or anomalies, spectral peaks derived from one of a plurality of mathematical transformations;
generating a plurality of vectors associated with the unique features of the secondary data set wherein the plurality of vectors are defined by vector parameters for the M×N matrix;
generating a hashed data set by applying a hashing technique to the plurality of vectors;
generating a plurality of data signatures from the hashed data set, wherein each data signature is a mathematical representation of a portion of the secondary data set,
generating a plurality of data signature matches from the plurality of data signatures by searching within the plurality of data signatures and a reference dataset;
generating a histogram of data signature matches at each depth in the one or more target wells; and
identifying the geological top in the one or more target wells by identifying a peak in the histogram.

2. The computer-implemented method of claim 1, wherein the standardizing the stored sensor data comprises at least one of normalization, mnemonic standardization, data series synchronization.

3. The computer-implemented method of claim 1, further comprising obtaining a set of data parameters from at least one of a user device and a parameter file;
identifying a set of target data located within a database, wherein the set of target data is filtered based on the set of data parameters;
filtering the stored sensor data on the database to the set of target data.

4. The computer-implemented method of claim 3, wherein the data parameters may comprise at least one of settings relevant to data handling, feature extraction, pattern matching criteria, and output format preferences.

5. The computer-implemented method of claim 1, further comprising applying a threshold to the standardized sensor data to generate a suitability metric;
comparing the suitability metric to a suitability threshold; and
refining the standardized sensor data a second time by performing data cleaning procedures on the standardized sensor data.

6. The computer-implemented method of claim 1, further comprising applying a threshold to the standardized sensor data to generate a suitability metric; and
comparing the suitability metric to a suitability threshold.

7. The computer-implemented method of claim 1, further comprising obtaining a set of constraints, wherein the constraints are obtained by a user device;
filtering the standardized sensor data based on the constraints.

8. The computer-implemented method of claim 7, wherein the constraints may comprise at least one of defining markers that cannot cross, sequence-based constraints, attribute-based constraints, proximity constraints, dynamic adjustment constraints, correlation-based constraints, directional constraints, multi-marker relationship constraints, error margin constraints, and environmental constraints.

9. The computer-implemented method of claim 7, further comprising obtaining a second set of constraints wherein the second set of constraints are obtained by a user device; and
filtering the standardized sensor data based on the second set of constraints.

10. The computer-implemented method of claim 1, wherein the hashing technique may comprise at least one of Locality Sensitive Hashing (LSH), Secure Hash Algorithm 1 (SHA-1), Secure Hash Algorithm 256 (SHA-256), Secure Hash Algorithm 512 (SHA-512), Message-Digest Algorithm 5 (MD5), MurmurHash, FNV (Fowler-Noll-Vo) Hash, CityHash, FarmHash, XXHash, Tabulation Hashing, Polynomial Hashing, SimHash, MinHash, Concatenation Hashing, or Hash Modulo.

11. The computer-implemented method of claim 1, wherein the matrix conversion technique comprises:
Assigning values of each element in the standardized data set to a bin in the secondary data set using the value as an index and quantizing using predetermined scaling.

12. The computer-implemented method of claim 1, wherein the matrix conversion technique generates a spectrogram.

13. The computer-implemented method of claim 1, wherein searching for data signature matches within the plurality of data signatures from the reference dataset comprises:
defining a reference search window centered on a marker in the reference dataset, wherein the search window spans a predefined range in the data domain;
and comparing the data signatures within the reference search window to those in one or more target datasets.

14. The computer-implemented method of claim 1, further comprising:
calculating a confidence metric by using two or more similarity algorithms;
determining a weighted average;
storing the geological top in a database;
storing the associated confidence metrics associated with the geological top in a database; and
displaying at least one of the geological top, weighted average and confidence metric on a user device.

15. The computer-implemented method of claim 14, wherein the confidence metrics may comprise at least one of a fingerprint density, match percentage, average match offset, target fingerprint percentage from the stored fingerprint data.

16. The computer-implemented method of claim 14, wherein displaying at least one geological top further comprises displaying on at least one of a map and cross section.

17. The computer-implemented method of claim 14, wherein determining a weighted average comprises:
taking the location of the pick for each method derived from a plurality of features or factors identified by similarity algorithms;
weighting each pick by the confidence metric associated with the respective feature or factor; and
calculating a weighted average location for the pick based on the weighted contributions of the confidence metrics.

18. The computer-implemented method of claim 1, wherein the vector parameters comprise at least one of frequency, time offset, and amplitude differences.

19. The computer-implemented method of claim 1, wherein the plurality of mathematical transformations comprise Short-Time Fourier Transform (STFT), Continuous Wavelet Transform (CWT), Wavelet Packet Transform (WPT), or Gabor Transform, and statistical measures including zero-crossing rates, signal energy, or entropy to highlight regions of interest.

20. A computing system for identifying geological tops from well log data, the computing system comprising:
obtaining sensor data from geological sensors, wherein the geological sensors are associated with a plurality of locations;
storing the set of sensor data on a database;
standardizing and conditioning the stored sensor data to generate standardized sensor data set;
replicating data points from the standardized data set and flattening the replicated data points into a one-dimensional linear series by interleaving data elements from each attribute across all replicated data points, wherein the resulting flattened series preserves the relative order and relationships of the original multi-attribute data;
upsampling the flattened data set to generate an intermediate dataset;
replacing the standardized data set with the intermediate dataset;
generating a secondary data set by converting the standardized data set into a secondary data format by using a matrix conversion technique, wherein the secondary dataset comprises an M×N matrix;
identifying unique features in the M×N matrix by detecting data patterns, the unique features comprising at least one of localized peaks, valleys, or extrema in the matrix values that represent transitions or anomalies, spectral peaks derived from one of a plurality of mathematical transformations;
generating a plurality of vectors associated with the unique features of the secondary data set wherein the plurality of vectors are defined by vector parameters for the M×N matrix;
generating a hashed data set by applying a hashing technique to the plurality of vectors;
generating a plurality of data signatures from the hashed data set, wherein each data signature is a mathematical representation of a portion of the secondary data set,
generating a plurality of data signature matches from the plurality of data signatures by searching within the plurality of data signatures and a reference dataset;
generating a histogram of data signature matches at each depth in the one or more target wells; and
identifying the geological top in the one or more target wells by identifying a peak in the histogram.

21. A computer readable medium comprising instructions that when executed by a processor enable the processor to:
obtaining sensor data from geological sensors, wherein the geological sensors are associated with a plurality of locations;
storing the set of sensor data on a database;
standardizing and conditioning the stored sensor data to generate standardized sensor data set;
replicating data points from the standardized data set and flattening the replicated data points into a one-dimensional linear series by interleaving data elements from each attribute across all replicated data points, wherein the resulting flattened series preserves the relative order and relationships of the original multi-attribute data;
upsampling the flattened data set to generate an intermediate dataset;
replacing the standardized data set with the intermediate dataset;
generating a secondary data set by converting the standardized data set into a secondary data format by using a matrix conversion technique, wherein the secondary dataset comprises an M×N matrix;
identifying unique features in the M×N matrix by detecting data patterns, the unique features comprising at least one of localized peaks, valleys, or extrema in the matrix values that represent transitions or anomalies, spectral peaks derived from one of a plurality of mathematical transformations;
generating a plurality of vectors associated with the unique features of the secondary data set wherein the plurality of vectors are defined by vector parameters for the M×N matrix;
generating a hashed data set by applying a hashing technique to the plurality of vectors;
generating a plurality of data signatures from the hashed data set, wherein each data signature is a mathematical representation of a portion of the secondary data set,
generating a plurality of data signature matches from the plurality of data signatures by searching within the plurality of data signatures and a reference dataset;
generating a histogram of data signature matches at each depth in the one or more target wells; and
identifying the geological top in the one or more target wells by identifying a peak in the histogram.
